(19) United States
(12) Patent Application Publication
(10) Pub. No.: US 2014/0156833 A1
(43) Pub. Date: Jun. 5, 2014

(54) SYSTEM AND METHOD FOR AUTOMATICALLY TRIGGERED SYNCHRONOUS AND ASYNCHRONOUS VIDEO AND AUDIO COMMUNICATIONS BETWEEN USERS AT DIFFERENT ENDPOINTS

(71) Applicant: Perch Communications Inc., Vancouver (CA)

(72) Inventor: Danny Brant Robinson, Vancouver (CA)

(73) Assignee: Perch Communications Inc., Vancouver (CA)

(21) Appl. No.: 14/088,290

(22) Filed: Nov. 22, 2013

Related U.S. Application Data
(60) Provisional application No. 61/729,410, filed on Nov. 22, 2012.

(51) Int. Cl. H04L 12/26

(52) U.S. Cl. CPC H04L 43/04
USPC 709/224

(57) ABSTRACT

A method for audio and/or video communication between at least two endpoints in a networked environment comprises receiving a plurality of data (data points) via a plurality of notifications/sensors/probes in the networked environment, said plurality of notifications/sensors/probes monitoring the data points; analyzing the data points to determine a state of each endpoint and correlating the state of each endpoint with at least one pre-identified state, comparing state of endpoint to at least one pre-identified state to recognize if an activation event is triggered, wherein if the activation event is triggered, an action related to the pre-identified state is taken, wherein at least one of the steps is carried out by a computer device.

### FIELD OF THE INVENTION

This invention relates to improvements in the field of video and audio communications between users who are generally at remote locations.

### BACKGROUND OF THE INVENTION

Traditional voice-based or image-based communication methods have relied on behavior first adopted with the telephone wherein communication is made by a user initiating a “call”, be it by dialing a phone number or looking up the person from a directory. In this form, communication is initiated with the caller having little or no context concerning the availability of the callee. Some systems may provide basic information about the availability of the callee, prior to a call being made, that may include indication on whether a user is available, busy, away or offline. However, these solutions have their own deficiencies, namely that such modes are limiting and often insufficient in accurately indicating a user's availability, or that these modes require a user's manual input to be updated.

Users have adopted many solutions to solve said deficiencies with the aforementioned traditional communication method. Some systems simply show a missed call while other systems allow the caller to leave a voicemail when the callee is not available. Other solutions have involved using secondary communication methods such as email or instant messaging, or calendaring systems to schedule an agreed upon time for a call, often after many correspondences.

This has led to the need for significant overhead using asynchronous communication to coordinate a time (e.g. email), in order to reliably initiate synchronous communication (e.g. phone call). Therefore, systems based on the aforementioned traditional method of communication, such as phone calls or videoconferences, are ineffective at enabling instant synchronous communication. Furthermore, these systems are ineffective at intelligently utilizing both asynchronous and synchronous communication to connect users.

Devices that are employed for voice-based or image-based communication have also changed significantly. Traditionally, such devices were very limited in their capabilities, often only able to perform a limited range of tasks, or executing a limited set of software. These devices were used solely to execute software necessary to carry out voice or image based communication (e.g. like a cellphone, having a contact list and be able to connect to a network to make phone calls). Other devices traditionally had the computational power to conduct video-based communication, but lacked hardware requirements such as a camera (e.g. a laptop).

With mobile devices such as smartphones and tablets, the devices employed for voice-based and video-based communication are much more capable and powerful. Said mobile devices are able to perform computationally intensive tasks and execute a wide range of software, often in parallel. These additions, along with the availability of a front-facing camera as a standard component on these devices, have made them popular with voice-based and video-based communication.

Furthermore, it is now possible to utilize mobile devices to gather data on a user. Some of this data may be collected by hardware sensors available on the devices such as accelerometers, GPS locators, wireless proximity sensors, or gesture detectors. Other data may be gathered by tracking and monitoring users' activities and interactions with the software on such devices, such functionality made possible by mobile devices' ability to multi-task when executing software. Finally, mobile devices also typically have reliable and high speed network connections that allows constant connection to timely transmit collected data or receive notifications.

Systems have leveraged these available data and network connections to form intelligent systems that leverage collected data from mobile devices and make recommendations or provide timely notifications. However, such systems, like Google Now, do not consider nuances specific to communications and are insufficient in intelligently managing communication forms that include asynchronous and synchronous forms. So, there are synchronous communications, like Skype, phone calls, etc. and conversely there are asynchronous communications, like Groupme, text messaging, MMS, etc. . . . To date, there is no simple, inexpensive technology to blend the two.

It is an object of the present invention to obviate or mitigate at some of the above disadvantages.

### SUMMARY OF THE INVENTION

It is an object of the invention to achieve intelligent communication management by a method of recognizing, collecting and analyzing various data points from at least one endpoint, which data points may form one or more activation events, wherein the data points are analyzed and activation events recognized using at least one means of data analytics.

It is an object of the present invention to utilize data available from a device and one or more connected systems, analyze said data to make intelligent conclusions that manage communications between the device and connected systems wherein said communications take both asynchronous and synchronous forms.

In one aspect, the present invention provides a method for audio and/or video communication between at least two endpoints in a networked environment which comprises receiving a plurality of data (data points) via a plurality of notifications/sensors/probes in the networked environment, said plurality of notifications/sensors/probes monitoring the data points; analyzing the data points to determine a state of each endpoint and correlating the state of each endpoint with at least one pre-identified state, comparing state of endpoint to at least one pre-identified state to recognize if an activation event is triggered, wherein if the activation event is triggered, an action related to the pre-identified state is taken, wherein at least one of the steps is carried out by a computer device.

The present invention further provides a computer storage medium encoded with a computer program, the program comprising instructions that when executed by one or more computers cause the one or more computers to perform operations relating to audio and/or video communication between at least two endpoints in a networked environment comprising: receiving a plurality of data (data points) via a plurality of notifications/sensors/probes in the networked environment, said plurality of notifications/sensors/probes monitoring the data points; analyzing the data points to determine a state of each endpoint and correlating the state of each endpoint with at least one pre-identified state, comparing state of endpoint to at least one pre-identified state to recognize if activation event is triggered, wherein if an activation event is triggered, an action related to the pre-identified state is taken

The present invention further provides a method for audio and/or video communication between at least two endpoints in a networked environment wherein a first user is at a first endpoint and a second user is at a second endpoint which comprises a) capturing and collecting data (data points) via a plurality of notifications/sensors/probes in the networked environment, relating to at least one of the first user and the first endpoint (first endpoint collected data), and analyzing the first endpoint collected data to determine a state of the first endpoint b) capturing and collecting data (data points) via a plurality of notifications/sensors/probes in the networked environment, relating to at least one of the second user and the second endpoint (second endpoint collected data) and analyzing the second endpoint collected data to determine a state of the second endpoint, c) correlating the state of at least one of the first endpoint and the second endpoint with at least one pre-identified state and comparing state of at least one endpoint to at least one pre-identified state to recognize if an activation event is triggered, wherein if the activation event is triggered, an action related to the pre-identified state is taken, wherein at least one of the steps is carried out by a computer device and wherein data points are analyzed and activation events recognized using at least one means of data analytics.

The present invention further provides a computer storage medium encoded with a computer program, the program comprising instructions that when executed by one or more computers cause the one or more computers to perform operations relating to audio and/or video communication between at least two endpoints in a networked environment wherein a first user is at a first endpoint and a second user is at a second endpoint comprising: a) capturing and collecting data (data points) via a plurality of notifications/sensors/probes in the networked environment, relating to at least one of the first user and the first endpoint (first endpoint collected data), and analyzing the first endpoint collected data to determine a state of the first endpoint b) capturing and collecting data (data points) via a plurality of notifications/sensors/probes in the networked environment, relating to at least one of the second user and the second endpoint (second endpoint collected data) and analyzing the second endpoint collected data to determine a state of the second endpoint, c) correlating the state of at least one of the first endpoint and the second endpoint with at least one pre-identified state and comparing state of at least one endpoint to at least one pre-identified state to recognize if an activation event is triggered, wherein if the activation event is triggered, an action related to the pre-identified state is taken and wherein data points are analyzed and activation events recognized using at least one means of data analytics.

The present invention further provides a system for audio and/or video communication between at least two endpoints in a networked environment wherein a first user is at a first endpoint and a second user is at a second endpoint which comprises:
a) a communication control server (CCS)
b) a video-over-telephony system (VOIPS) enabling communication between first endpoint and second endpoint;
c) at least one video and/or audio capture device and microprocessor at a each of first endpoint and second endpoint;
d) at least one external data interface and storage (EDIS);
   wherein said CCS collects data points, analyzes data points and compares the state of at least one endpoint to at least one pre-identified state to recognize if an activation event is triggered, wherein if the activation event is triggered, an action related to the pre-identified state is taken.

A method for optimizing the conveyance and display of information to a first user at a first endpoint in regards to an audio and/or video communication between at least two endpoints (including the first endpoint) in a networked environment which comprises:

a) capturing and collecting data (data points) via at least one of i) a plurality of notifiers/sensors/probes in the networked environment, relating to at least one of the first user and the first endpoint and ii) an external data interface and storage system (EDIS) and wherein such data points relate at least to the first user, the environment and the endpoints and wherein EDIS comprises appropriate API Connectors to access, query and acquire the data points from the external systems;
b) comparing the data points to a proposed start time for an audio and/or video transfer/communication requiring presence and/or engagement of the user; and
c) leveraging the data points to augment the way in which one or more of the endpoints are accessible to, visible to or arranged for the first user.

One aspect of the present invention is the seamless blending of asynchronous and synchronous communications between users at remote locations. Another aspect of the present invention is the instant toggling of a communication between an asynchronous conversation into a live two or multiple way synchronous conversation. Another aspect of the present invention is the preferred adoption of data analytics algorithms to collect and analyze data points and to recognize activation events with the purpose of improving video and audio communications between remote locations. Another aspect of the invention is the collection and analysis of data points and the recognition of activation events with the purpose of controlling an auto-connect portal between a first endpoint and a second (remote from the first) endpoint wherein data (including but not limited to cues and contextual information related to a user at an endpoint and the endpoint itself) is used to determine which “optimal” endpoints to connect at any given point in time. Another aspect of the invention is the collection and analysis of data points (including but not limited to cues and contextual information related to a user at an endpoint and the endpoint itself) and the recognition of activation events with the purpose of determining which “optimal” endpoints to connect to and to intelligently selecting an optimal endpoint (of many) on which user may accept data (for example call, email or other transmission). Another aspect of the invention is the collection and analysis of data points (including but not limited to cues and contextual information related to a user at an endpoint and the endpoint itself) and the recognition of activation events with the purpose of transferring data (for example call, email or other transmission) between multiple endpoints. Another aspect of the invention is the collection and analysis of data points (including but not limited to cues and contextual information related to a user at an endpoint and the endpoint itself) and the recognition of activation events with the purpose of optimizing a particular endpoint to which to send data. Another aspect of the invention is the collection and analysis of data points (including but not limited to cues and contextual information related to a user at an endpoint and the endpoint itself) and the recognition of activation events with the purpose of activating audio on a continually live video stream (for example, activating video only when a face is detected). Another aspect of the invention is the collection and analysis of data points (including but not limited to cues and contextual information related to a user at an endpoint and the endpoint itself) and the recognition of activation events with the purpose of setting up meeting queues and optimal connections between at least two users.

These and other advantages of the invention will become apparent throughout the present disclosure.

### BRIEF DESCRIPTION OF THE FIGURES

The following figures set forth embodiments in which like reference numerals denote like parts. Embodiments are illustrated by way of example and not by way of limitation in all of the accompanying figures in which:

FIG. 1 illustrates a machine-implemented communication system that facilitates and/or effectuates synchronous and asynchronous communication of video and/or audio data between Endpoint A and Endpoint B;

FIG. 2 illustrates the particulars of a Video Telephony over IP System;

FIG. 3 illustrates a system comprising a Communication Control Centre (CCS) and relationship with endpoints and data point sources, VOIPS, and EDIS;

FIG. 4 illustrates a system comprising a EDIS and relationship with data point sources;

FIG. 5 illustrates an example of a decision matrix in accordance with an embodiment of the present disclosure;

FIG. 6 illustrates an example of a decision matrix in accordance with an embodiment of the present disclosure;

FIG. 7 illustrates an example of a face-detection driven microphone process in accordance with an embodiment of the present disclosure;

FIG. 8 illustrates an example of a meeting queue in accordance with an embodiment of the present disclosure;

FIG. 9, illustrates an auto-connect with multiple endpoints process in accordance with an embodiment of the present disclosure.

### DETAILED DESCRIPTION OF THE INVENTION

A method, system and device for management of communication between devices are described herein. A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

The term “device” and “mobile device” refer herein interchangeably to any computer, microprocessing device, personal digital assistant, Smartphone other cell phone, tablets and the like.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

The term “data” or “data point” comprises at least one of: user specific features, endpoint features, user identity, user presence, environmental features at the endpoint, external features, cues and inputs (for example, external features, cues, inputs and activities relating to a user, a company or a group, including calendar systems, email systems, contact lists and social networks, enterprise collaboration systems), user generated data points (for example, data points generated or acquired by software or applications used by or connected to a user), analytics and intermediary data generated by machine learning processes/systems and specific, pre-determined settings relating to the relationship between the first endpoint and the second endpoint. More specifically, data (data points) may relate to at least one of the user presence and identity and are captured and collected by at least one of: proximity detection means, facial detection means, voice detection means, motion detection means, gesture detection means, biometric detection means and audio detection means. Alternatively, data (data points) may relate to environmental features selected from the group consisting of: time at an endpoint, day at an endpoint, weather at an endpoint, ambient light at an endpoint, physical location of an endpoint, network to which endpoint connected (or connectable), user at endpoint, group presence at endpoint, and corporate presence at endpoint. Alternatively, data (data points) may relate to at least one of user cues and endpoint cues and are selected from the group consisting of: system notifications to user, previous connection history of user to any endpoint, previous connection patterns of user to any endpoint, user's availability, user's location and user's mobility. Alternatively, data (data points) may relate to at least one of user's availability, location and mobility, any of which are detected via feedback from user's networked mobile device.

In a preferred embodiment, data points comprise a user's biometric information, including detecting or recognizing a user's face, fingerprints, or voice prints. In a further preferred embodiment, data points comprise data from a user's environment, including the time of day, the level of ambient light or the level of movement. In another preferred embodiment, data points comprise information from computer systems that the user interacts with, including the communication system, enterprise systems and network systems.

The term “action”, as used herein is selected from the group consisting of: transmission of data between endpoints, transmission of audio between endpoints, transmission of video between endpoints, transmission of user presence data, initiation of a call between the first user and the second user, transferring a call by at least one user, sending a notification to the first user, the second user or a third party, transmission of a prompt to a user to take an action, storage of data, updating data, generating or updating data for use within the system, making computational changes to existing data/datapoints and other actions as are defined by the user via the system. In one aspect, an action comprises streaming data to a server and thereafter, either synchronously or asynchronously (in any combination thereof) to one or more intended users/recipients, at remote endpoints.

The term activation event is the result of/is formed by a pre-determined combination of data points, wherein said pre-determined combination of data points is selected by one of: a) a third party service provider; b) a network provider; and c) a user. Data points are collected and analyzed within the scope of the present invention to determine if an activation event is cued/triggered. The exact combination of data points to cue any given activation event varies and is based on one or more pre-determined parameters. An activation event then triggers (or does not trigger) the occurrence of one or more actions.

Within the scope of the present invention, data points are analyzed and activation events recognized using “at least one means of data analytics”. “Data analytics” comprises one or a combination of methods of processing the data points and includes, but is not limited to: simple Boolean programmable logic, expert systems, probabilistic methods and adaptive methods (preferably machine learning and most preferably combined with data-mining).

Most preferably, artificial intelligence (AI) methods are used to analyze the data points. Methods that leverage IF-THEN rule sets such as expert systems wherein an inference engine makes decisions based on rules within a knowledge base, may be also used. In another aspect, probabilistic methods such as Bayesian networks and corresponding Bayesian methods may be used to analyze data points.

Machine learning may be used to analyze the data points to determine a state of each endpoint and to recognize if the activation event is triggered. Stochastic modeling may be used or supervised machine learning methods, including Support Vector Machines, Decision Trees, and Naieve Bayesian.

By way of example, in a scenario wherein data points detect a face, and an activation event prescribes that if any face is detected then the action is—mic to be unmuted, then it is preferred that a simple Boolean programmable logic is used to link data points, activation event and action. However, if additional variables need to be accounted for, like face detection, user proximity (via location) detection, and time of day of detection for the action to be auto connect, it is preferred to implement the method with a more robust means of data analytics, for example, expert systems (in essence, a more sophisticated way of handling several sets of “IF THEN” rules).

Probabilistic methods gather data and apply a probability, based on the state of the data, to determine what is the likely state. This adds further flexibility (it's not rigid logic like with Boolean) to the means of data analytics. Also, it is possible to use machine learning combined with data-mining to make the entire method intelligent and adaptive to historical trends.

As used herein the term “Perch Platform” refers to one possible host of the Communication Control server (CCS). More preferably, such a CCS comprises at least i) a data sources hub; ii) a decision unit; iii) activation event database and iv) CCS database, all described in further detail below. In one aspect, the Perch Platform may be offered to customers as a software-as-a-service or subscription based service. Most preferably, the elements of the Perch Platform are hosted in a Cloud based environment.

In one aspect, and as described further below, the audio and/or video capture device may include an automatic switch configured to toggle between record and interlude modes based upon the occurrence of an activation event. In one aspect of the present invention, audio and/or video capturing device is powered up and engaged in a “watch mode”, in anticipation of an activation event, such event preferably suggesting the occurrence of something of interest to be captured and shared with recipients, via the method and system of the invention. In another preferred aspect, audio and/or video capturing device is powered up and engaged in a “record mode”, in anticipation of an activation event, such event preferably suggesting the occurrence of something of interest to be captured and shared with recipients, via the method and system of the invention. In the event of any of the activation events, it is assumed that: 1) data to be transmitted by the processor, in the device to the server; 2) the server will convey notification (for example by text message, email, social media notice etc. . . . ) that data (whether in video form, audio form or a combination thereof) is available for live streaming or acquiring later i.e. missed content can be viewed/heard at a future point in time and/or saved.

The system and method of the present invention provides that users at remote locations can, via live streaming, communicate (send text, video and audio data) in real time (synchronous communication) or in off-set time (asynchronous communication).

As used herein, synchronous communication means “direct” communication where the communicators are time synchronized. This conventionally means that all parties involved in the communication are “present” online or connected at the same time. This includes, but is not limited to, a telephone conversation (not texting), a company board meeting, a chat room event and instant messaging.

As used herein, asynchronous communication does not require that all parties involved in the communication to be present at the same time. Some examples are e-mail messages, discussion boards, blogging, and text messaging over mobile devices, for example over mobile/cellular devices. For example, a friend A sends friend B an e-mail message. Friend B later reads and responds to the message. There is a time lag between the time A sent the message and B replied, even if the lag time is short. Bulletin board messages can be added at any time and read at A and B's leisure; B does not read A's message as it is being created, and you can take as much time as you need to respond to the post. Asynchronous activities take place whenever recipients have the time to engage.

There are some key advantages to asynchronous engagement. For one thing, it enables flexibility. Participants can receive the information when it's most convenient for them. There is less pressure to act on the information or immediately respond in some way. People have time to digest the information and put it in the proper context and perspective.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b). The title of the present application and headings of sections provided in the present application are for convenience only, and are not to be taken as limiting the disclosure in any way.

In a preferred mode, audio and/or image capturing device is a microphone and camera assembly formed as part of mobile device, for example, a Smartphone, a tablet or a laptop computer. In another preferred mode, audio and/or image capturing device is a microphone and camera assembly formed as part of a desk top computer and/or screen. In a preferred mode, the recipient audio and/or video viewing device is a mobile device, for example, a Smartphone, a tablet, desk top computer or laptop computer. In another preferred mode, all participants send and receive audio and video data to each other via mobile devices such as tablets and Smartphones in operable communication with the server.

In another preferred aspect, one or both of the image capturing device and image receiving device are iPhones, iPad or other devices operating via iOS. For example, an iPad can be installed on a wall, in a house (or several throughout a house) and these are powered up and engaged in a “watch mode”, in anticipation of an activation event, such event preferably suggesting the occurrence of something of interest to be captured and shared with recipients, via the method and system of the invention.

In one aspect, the present invention provides a method for audio and/or video communication between at least two endpoints in a networked environment which comprises receiving a plurality of data (data points) via a plurality of notifications/sensors/probes in the networked environment, said plurality of notifications/sensors/probes monitoring the data points; analyzing the data points to determine a state of each endpoint and correlating the state of each endpoint with at least one pre-identified state, comparing state of endpoint to at least one pre-identified state to recognize if an activation event is triggered, wherein if the activation event is triggered, an action related to the pre-identified state is taken, wherein at least one of the steps is carried out by a computer device.

The present invention further provides a computer storage medium encoded with a computer program, the program comprising instructions that when executed by one or more computers cause the one or more computers to perform operations relating to audio and/or video communication between at least two endpoints in a networked environment comprising: receiving a plurality of data (data points) via a plurality of notifications/sensors/probes in the networked environment, said plurality of notifications/sensors/probes monitoring the data points; analyzing the data points to determine a state of each endpoint and correlating the state of each endpoint with at least one pre-identified state, comparing state of endpoint to at least one pre-identified state to recognize if activation event is triggered, wherein if an activation event is triggered, an action related to the pre-identified state is taken

The present invention further provides a method for audio and/or video communication between at least two endpoints in a networked environment wherein a first user is at a first endpoint and a second user is at a second endpoint which comprises a) capturing and collecting data (data points) via a plurality of notifications/sensors/probes in the networked environment, relating to at least one of the first user and the first endpoint (first endpoint collected data), and analyzing the first endpoint collected data to determine a state of the first endpoint b) capturing and collecting data (data points) via a plurality of notifications/sensors/probes in the networked environment, relating to at least one of the second user and the second endpoint (second endpoint collected data) and analyzing the second endpoint collected data to determine a state of the second endpoint, c) correlating the state of at least one of the first endpoint and the second endpoint with at least one pre-identified state and comparing state of at least one endpoint to at least one pre-identified state to recognize if an activation event is triggered, wherein if the activation event is triggered, an action related to the pre-identified state is taken, wherein at least one of the steps is carried out by a computer device and wherein data points are analyzed and activation events recognized using at least one means of data analytics.

The present invention further provides a computer storage medium encoded with a computer program, the program comprising instructions that when executed by one or more computers cause the one or more computers to perform operations relating to audio and/or video communication between at least two endpoints in a networked environment wherein a first user is at a first endpoint and a second user is at a second endpoint comprising: a) capturing and collecting data (data points) via a plurality of notifications/sensors/probes in the networked environment, relating to at least one of the first user and the first endpoint (first endpoint collected data), and analyzing the first endpoint collected data to determine a state of the first endpoint b) capturing and collecting data (data points) via a plurality of notifications/sensors/probes in the networked environment, relating to at least one of the second user and the second endpoint (second endpoint collected data) and analyzing the second endpoint collected data to determine a state of the second endpoint, c) correlating the state of at least one of the first endpoint and the second endpoint with at least one pre-identified state and comparing state of at least one endpoint to at least one pre-identified state to recognize if an activation event is triggered, wherein if the activation event is triggered, an action related to the pre-identified state is taken and wherein data points are analyzed and activation events recognized using at least one means of data analytics.

The present invention further provides a system for audio and/or video communication between at least two endpoints in a networked environment wherein a first user is at a first endpoint on a first system and a second user is at a second endpoint on a second system which comprises: a communication control server (CCS), a video-over-telephony system (VOIPS) enabling communication between first endpoint and second endpoint; at least one video and/or audio capture device and microprocessor at a each of first endpoint and second endpoint; at least one external data interface add storage (EDIS); wherein said CCS collects data points, analyzes data points and compares the state of at least one endpoint to at least one pre-identified state to recognize if an activation event is triggered, wherein if the activation event is triggered, an action related to the pre-identified state is taken.

In one embodiment, user's face data is gathered by an imaging device as part of a communication endpoint and is analyzed to detect the presence of a user's face. Upon the detection of the presence of a face, the system unmutes the microphone that is part of the same communication endpoint. In addition, communication endpoint begins to transmit the captured audio data to other communication endpoints.

In another embodiment, data is gathered from the communication system itself and actions are taken on the communication system. This embodiment details in some states, action is taken on the communication system that includes storing user data, or updating data within the communication system. The embodiment further details that at a later time, said data is gathered by the system as part of its operation and analyzed to determine the state of the communication system. For example, an action may be to update the data that represents the presence of a user at a communication endpoint. This data can be gathered by the system at a later time and analyzed to determine the need to initiate a communication channel based on the user's presence.

The above claimed method can be applied to a wide-ranging set of embodiments, depending on the data monitored, and the actions taken, beyond the aforementioned embodiments.

It is understood by a person having ordinary skill in the art that all references to video telephony may include voice and/or video data to be transmitted in a communication channel. For brevity, all voice and/or video telephony communication will be referred to as simply video telephony.

The method and system of the present invention is illustrated, by way of example, in the attached four figures. These figures set forth embodiments in which like reference numerals denote like parts.

### Communication System

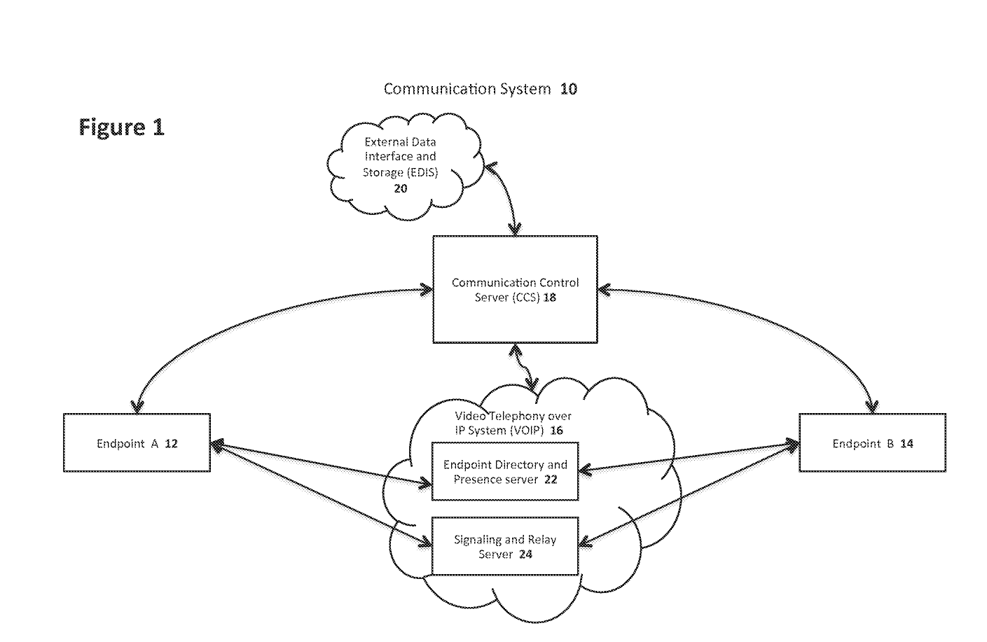

FIG. 1 illustrates an exemplary embodiment of the claimed communication system, shown generally at 10. The communication system comprises two Endpoints 12 and 14, a Video-Telephony over IP System (VOIPS) 16, a centralized Communication Control Server (CCS) 18 and a multitude of External Data Interface and Storage (EDIS) 20. In an exemplary embodiment, video telephony communication is enabled between Endpoints 12 and 14 by the VOIPS 16 through endpoint directory and presence server 22 and signaling and relay server 24. The operation of said video telephony communication is managed by CCS 18 as it provides overall management of the communication system. Primarily, the CCS monitors data sources sourced from throughout the Communication System, including the Endpoints 12 and 14 and EDIS 20, and analyzes said data to determine the state of the system and in turn, takes pre-determined actions depending on the state of the system and as described further herein.

In one specific example of the implementation of a system like FIG. 1, in operation, there may be provided a variable synchronous/asynchronous two-way audio/video communications system with user a) at Endpoint 12 (at one location) and user b) at Endpoint 14 (at a location remote from the location of a)). User a) may have a mobile device comprising interface/display and an image capture device (for example a camera) and an audio capture device. Device is enabled with the communications application of the present invention.

The device manages the capture, processing and transmission audio/video images across a network, possibly subject to handshake protocols, privacy protocols, and bandwidth constraints. The network is supported remote server within a cloud.

A computer (or control logic processor (CPU)) coordinates control of a audio/image capture and a system controller provides display driver and image capture control functions. System controller can be integrated into the computer or not as desired.

Further detail of each of the aforementioned components of the Communication System is provided herein.

### Endpoints

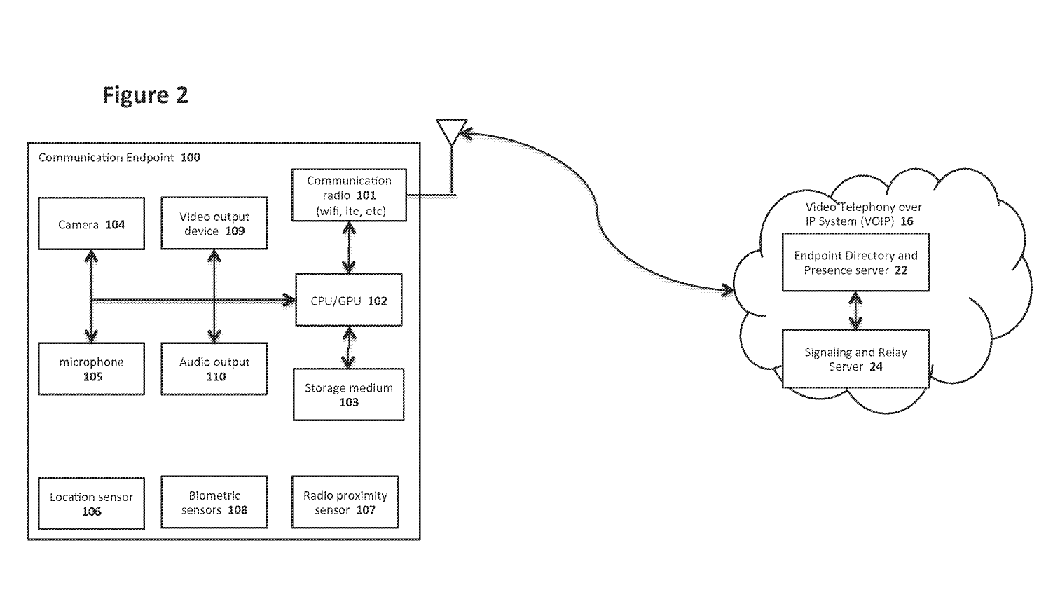

FIG. 2 illustrates preferred components of a Communications Endpoint 100, wherein said Communications Endpoint 100 is in networked engagement with VOIPS 16 the deployment in conjunction thereof to conduct video telephony communication.

Endpoint 100 comprises a computing device that comprises of a central processing unit (CPU) 102 and storage medium 103 for the operation of a computing device. The computing device may optionally contain additional processors beyond a central processing unit, such as a graphical processing unit (GPU). Storage medium 103 within Endpoint 100 may comprise of random access memory for short term caching of data or long term storage of data such as through a hard disk or solid state disk. Endpoint 100 shall also comprise of communication equipment 101 as is necessary to make a network connection to conduct Video Telephony Communication. PHOSITA will recognize that many options are applicable as communication equipment in this scenario. Communication equipment that are applicable comprise of equipment that practices standards including but not limited to, cellular network standards defined by industry groups such as 3^{rd} Generation Partnership Projects (3GPP) and 3^{rd} Generation Partnership Projects 2 (3GPP2), such as UMTS, HSPA, LTE, and communication technologies described in standards developed by the Institute of Electrical and Electronics Engineers Standards Association, such as Ethernet, WLAN, or Bluetooth. Endpoint 100 shall also include either an image capture device, such as a CMOS camera 104 for video-based telephony or an audio capture device, such as a microphone 105 for voice-based telephony. Alternatively, the Endpoint 100 may also include both image and audio capture device for an image-based and voice-based telephony. The Endpoint 100 may also include either a video output device 109 or audio output device 110, as is necessary to output video or audio data received in conducting Video Telephony Communication as is applicable. The Endpoint 100 may also include one or more of a location sensor 106, biometric sensors 108 and radio proximity sensor 107.

FIG. 2 further illustrates components of VOIPS 16 including endpoint directory and presence server 22 and signaling and relay server 24.

Preferably, audio capture device 105 comprises at least one microphone such as omni-directional or directional microphone or other devices that can perform the function of converting sonic energy into a form that can be converted by audio processing circuit into signals that can be used by a computer and can also include any other audio communications and other support components known to those skilled in the audio communications arts.

Audio output 110 (an audio emission device) can comprise a speaker or any form of device known that is capable of generating sonic energy in response to signals generated by audio processor and can also include any other audio communications and other support components known to those skilled in the audio communications arts. Audio processor can be adapted to receive signals from the computer and to convert these signals, if necessary, into signals that can cause audio emission device to generate sound and/or other forms of sonic energy such as ultrasonic carrier waves for directional sonic energy. It will be appreciated that any or all of audio capture device, audio emission device, audio processor or computer can be used alone or in combination to provide enhancements of captured audio signals or emitted audio signals, including amplification, filtering, modulation or any other known enhancements.

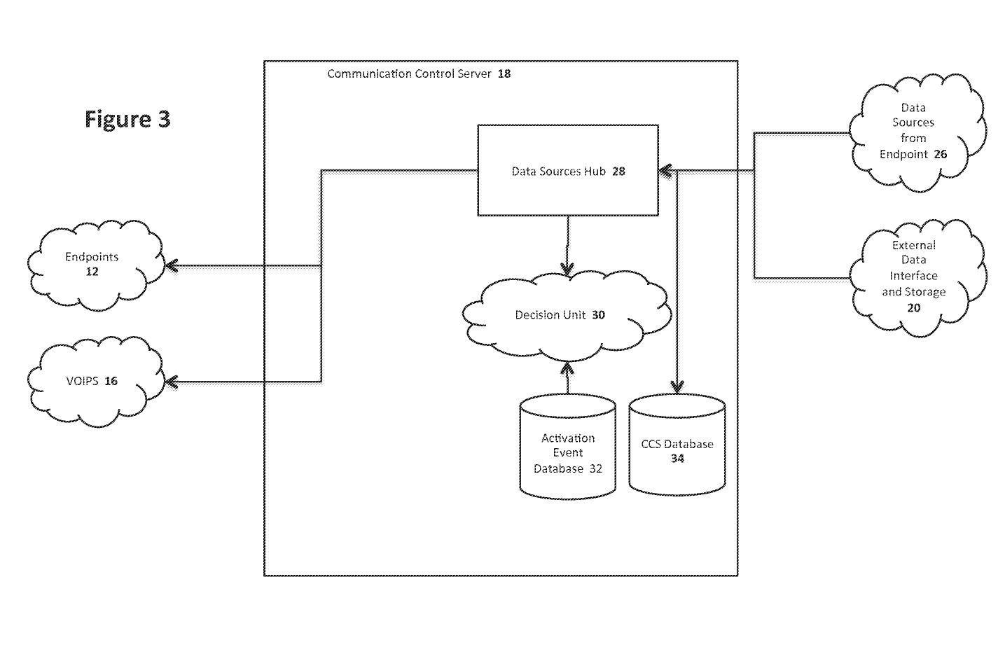

FIG. 3 further illustrates components of CCS 18 and its relationship with Endpoint 12, VOIPS 16, data point sources from Endpoint 26 and EDIS 20. In particular, CCS 18 comprises Data Sources Hub 28, Decision Unit 30, Activation Event Database 32 and CCS Database 34.

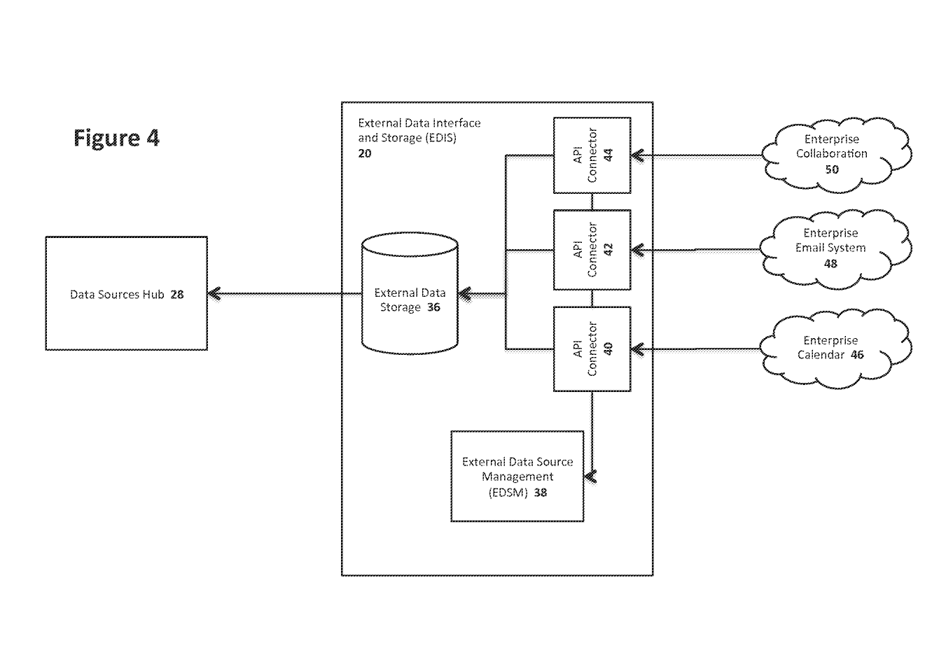

FIG. 4 further illustrates the components of EDIS 20 and its relationship with Data Sources Hub 28 (within CCS 18) and a plurality of data point sources. In particular, EDIS 20 comprises External Data Storage 36, External Data Source Management 38 and a plurality of API Connectors, 40, 42 and 44. API Connector 40 is in networked communication with Enterprise Calendar 46. Connector 42 is in networked communication with Enterprise Email System 48. Connector 44 is in networked communication with Enterprise Collaboration 50. Data acquired from API Connectors, 40, 42 and 44 is stored in External Data Storage 36 before conveyance to Data Sources Hub 28 within CCS 18.

It is to be understood that within the scope of the invention, the Communication System monitors a multitude of data points to determine the operation of said Communication System. While the source of data points can be varied (as described herein), one source is an Endpoint of the Communication System. Significant data can be collected at the Endpoint as it is the primary and most direct interface between the Communication System, and the user thereof and this user's environment. Data from Endpoints may be captured via sensors that detect real-world signals and transduces it for use in a computer system. Said data can also originate from information stored in software through its operation, or through interaction with the user.

Information Gathered from Endpoints

As such, endpoints may also comprise a collection of notifiers/sensors/probes capable of collecting data points related to the endpoint to provide information relevant to the endpoint, such as, for example, the presence and identity of the users and environmental state of the endpoint. It is not intended that the method and system of the present invention be limited to specific notifiers/sensors/probes or data capture devices. The aforementioned notifiers/sensors/probes may comprise a hardware component (for example, a transducer) to detect real-world data and a software component to execute post-processing of the real-world data into usable computer system compatible information. The endpoints query the sensors for the processed information and may temporarily store this information in the Storage Medium in the Endpoint. This data may be queried by the Endpoint, or other components of the Communication System, at a later time, where said data may be retrieved from the Storage Medium and transmitted to the querying component. For example, the Communication Control Server, during its operation, may query the Endpoint for data. The Endpoint can retrieve the requested information from the Storage Medium and transmit it to the CCS to determine the state of the system and the appropriate action.

In one embodiment, an endpoint can contain sensors that give geographical and distance data in relation to the Endpoint (Location Sensors). Location Sensors may use a variety of methods, or a combination thereof, such as, for example, radio signal triangulation, radio signal time of flight or inertial navigation to determine the sensor's absolute location, relative location or movement. The Location Sensor may contain software functions to further analyze the aforementioned data. For example, relative location of two locations can be processed to attain the absolutely position of one location, if the absolute position of the other location is known. Alternatively, detected movement such as acceleration and speed, can be analyzed to calculate distance travelled, using well-known relationships between acceleration, speed and distance. Commonly known sensors that are examples of Location Sensors include using GPS positioning chips to determine absolute location, cell-tower/Wi-Fi/Bluetooth signal triangulation to determine relative location or accelerometers and gyroscopes to detect physical movement of the Endpoint.

Furthermore, Location Sensors may provide proximity data either by analyzing the collected aforementioned geographical data or by utilizing radio signal to provide simple Boolean data on whether two locations are in proximity to each other. In one example, a specified area, or maximum distance from a location may be defined as a parameter such that should the absolute location of one location is in the specified area, within the maximum distance, the Location Sensor registers data to show two locations are in proximity to each other. Alternatively, Location Sensors can detect radio signals of nearby devices that are transmitting radio signals and determine the proximity of said devices by monitoring the received signal strength. It should be clarified further that while the aforementioned methods can determine the proximity of two Endpoints, a Location Sensor of an Endpoint can leverage the same methods to determine the proximity of nearby devices that may not be Endpoints, but broadcasts compatible radio signals such that the aforementioned methods can be utilized.

In another embodiment, an Endpoint can contain a presence or motion sensor to detect any movement at an Endpoint, or presence of a user. Some sensors that provide motion sensor include, for example, infrared motion sensors and radio frequency tomographic motion sensors. Furthermore, an image sensor (for example a camera) at an Endpoint can be utilized in additional ways by using software to analyze the image-based data captured by the camera. Using the appropriate software analysis algorithms, motion can be detected. For example, one such algorithm involves by looking for difference in the image, at the pixel level, from one frame in time to that of another and identifying the number of different pixels. Detecting motion can provide information about the presence of users and the level of user activity at an Endpoint. The ability to detect motion can further enable users to give commands through gestures. Furthermore, the image-based data can be analyzed to detect features such as a user's face, including its orientation and position. Beyond that, the same image-based data can be further analyzed using the appropriate algorithms, in conjunction with reference points, to not only detect but to identify faces as specific users for added context about the presence of a user.

In another embodiment, the microphone in an Endpoint can be utilized for more than transducing sound into signals for Video Telephony Communication. The microphone can be utilized to detect ambient noise at an Endpoint, providing further information about the presence of users and/or level of activity at an Endpoint. The same microphone can be used to collect raw audio data to be processed with the appropriate software algorithms, utilizing audio reference points such as voice samples, to identify users' voices, or to recognize spoken instructions.

In another embodiment, the endpoint can utilize biometric sensors to gather biometric data and determine the identity of users interacting with an Endpoint. Biometric sensors leverage distinctive, measurable characteristics or traits to identify individuals. Physiological traits such as fingerprint, palm print, DNA, iris/retina recognition or odor and scent are all contemplated methods in the current state of the art.

Aside from hardware sensors, data from Endpoints may also be generated through operation, or through users' interaction with such Endpoints. Such data may also be collected to provide information on the operation of the Endpoint, or usage patterns of the Endpoint. The detection of this type of data can be implemented in software, as part of the software that operates the Endpoint

In one embodiment, software of an Endpoint may detect and record data pertaining to the history of Video Telephony Communications made over a period of time. Such data may include the time and duration of said communication, as well as the participants of said communication.

In another embodiment, network information may be assigned in the course of the operation of the software of an Endpoint. Said information may be stored to provide information about the Endpoint within the network hierarchy. For example, network information such as Internet Protocol (IP) addresses may be assigned in order for the Endpoint to connect to a network. The IP Address can be compared to similar information of other Endpoints to determine additional information pertaining to the relationships between Endpoints. Such network information utilize standardized methods to assign network information and in some cases, for example, can determine the logical grouping of Endpoints depending on the logical division of each Endpoint's network information. Examples of such methods include utilizing an Endpoint's IP address and comparing it to other IP addresses and their respective subnets to determine the location each Endpoint is within the network topology. This type of information assists in identifying or grouping Endpoints.

Furthermore, unique identifiers assigned to Endpoints, which may include identifiers assigned in a software process, or as part of the manufacturing process of hardware components, can identify Endpoints. Examples of identifiers assigned in a software process include the assigning of network addresses, user generated usernames, or identifiers assigned as part of the operation of software. Examples of hardware-assigned identifiers include a network component's Media Access Control (MAC) address or a serial number. By being able to uniquely identify an Endpoint, the Communication System can establishing unique relationships between users and Endpoints. Such relationships allow the Communication System more information to infer the presence of users or Endpoints, given less information.

The Endpoint described above may be embodied by typical computing devices such as an iPhone, and iPad, a laptop with a camera or a desktop with a camera.

### Video Telephony Over IP System

The Video Telephony over IP System (VOIPS) is a computer system that provides telephony services to enable video telephony communication between Endpoints. It comprises of the Directory and Presence Server (DPS) and a Signaling and Relay Server (SRS). Endpoints connect to the VOIPS over a network connection to exchange necessary data to facilitate VTC, including system data (such as presence) and video and audio data. Said network connection between Endpoints and VOIPS can be established by any available communication radio equipment supported by the Endpoints. Endpoints can also alternatively use available communication radio equipment to connect to an intermediary network and from said intermediary network to VOIPS through traditional wired networks. For example, an Endpoint may connect to the VOIPS via its communication radio equipment, such as a cellular wireless connection, wireless to the cellular network. The cellular network in turn connects to an intermediary network, such as an internet gateway within the cellular network, and onto the VOIPS through the global connected network of the Internet. Endpoints is also capable of connecting directly to each other in the aforementioned manner, particularly in the process of establishing a direct connection to exchange video and audio data, as part of VTC.

The DPS maintains a directory of Endpoints provisioned within the Communication System. The Communication System relies on unique identifiers for Endpoints to be able to identify and make a connection to a desired Endpoint. The DPS manages the provisioning, maintenance and storage of said unique identifiers. The DPS may utilize a variety of methods known in the state of the art to create unique identifiers, including using hardware unique identifiers from the Endpoint, like Media Access Control Access (MAC address) or user-generated identifiers such as usernames. The DPS may also store presence information related to each Endpoint such as the availability of each Endpoint, or the state of each Endpoint, including but not limited to being, offline, online, away, occupied and in a call or available. The aforementioned stored data are retrieved and accessed from time to time by the SRS to facilitate VTC. In initiation VTC between two Endpoints, the SRS may query the DPS for the presence and availability of an Endpoint. For example, to establish a VTC connection, the SRS may also query the DPS for the unique identifier for the Endpoints to be connected. From time to time, in operation, Endpoints within the communication system may submit updated presence and unique identifier data, or other data as is necessary to facilitate VTC, to the VOIPS and in turn to the DPS.

The SRS is a computer system within the VOIPS that interfaces with Endpoints to facilitate VTC. Upon a desire to initiate communication between Endpoints, the SRS acquires the unique identifier for the desired Endpoints from the DPS, verifies the suitability of the Endpoints' presence, and upon positive verification of presence, signals to the respective Endpoints instructions to establish a connection for video telephony communication. Said instructions may include the unique identifier for the respective Endpoints. The SRS shall also receive signals upon the conclusion of VTC, updated information about the Endpoints including unique identifiers or presence. The SRS provides the aforementioned updates to the DPS to maintain the operation of the VOIPS.

Upon receipt of the signals to initiate VTC by the Endpoints, each Endpoint attempts to establish a connection to the corresponding Endpoint using the necessary information provided by the SRS. With the given information, the Endpoints attempt to establish a direct connection to transfer data. Should a connection be successfully made, video and voice data for the VTC is transferred between the Endpoints. SRS may also have functionality to relay a connection between the corresponding Endpoints, should the Endpoints be unable to establish a connection to transfer data. Such scenarios may include issues involving traversal of network address translation wherein the solution involves using the SRS as an intermediary connection point between the corresponding Endpoints and relaying the data between the Endpoints.

The aforementioned embodiment is one possibility of how the Endpoints and VOIPS can interact. In another embodiment, the VOIPS is much less central to the communication between Endpoints. In this alternate embodiment, the DPS and SRS still maintain their main function. However, the directory data stored within the DPS may also be stored in each Endpoint. As previously mentioned, the DPS maintains an updated directory of the Endpoints in the Communication System, including unique identifiers and presence information. In this alternate embodiment, said data within the directory are updated, and also transmitted to each Endpoint such that each Endpoint has access to said data locally (without needing to query via a network). This enables the Endpoint to determine the availability of other Endpoints and if instructed, be it by the CCS, or by a user, initiate VTC with the relevant Endpoint.

Furthermore to this alternate embodiment, each Endpoint may initiate VTC, instead of the CCS initiating VTC. Each Endpoint, upon instruction by the CCS or by a user to initiate VTC, may attempt to establish a connection with the relevant Endpoint, in the same manner as previously mentioned. Should an attempt fail to establish, Endpoints may elect to each establish a connection to the SRS and utilize the SRS to relay the video and/or audio data, as part of the VTC.

### SRS—Switching Streams

In one embodiment of the invention, the VOIPS has the functionality to transfer an in-progress video telephony communication between two Endpoints from one Endpoint to another. Such transfer can be initiated by a user in a VTC, by the SRS, or by the Data Analyzer as is determined to be the appropriate action given the state of the system.

Traditional video telephony systems may enable the same functionality to transfer a call from one endpoint to another. The best user experience in transferring a stream is one that is immediate, with a smooth transition from one endpoint to the other. However, such implementations have their own limitations, often failing at providing the best user experience by transferring a stream immediately with smooth transition from one endpoint to the other. A common deficiency results in the video stream to briefly pause, or the video stream quality may degrade, while a new connection to the new endpoint is established, or the connection is of sufficient quality to maintain a seamless transition.

The above deficiencies are due to the fact that there is significant overhead in both time and data sent in the process of establishing a new network connection. To establish a network connection, computer systems utilize an agreed upon network protocol to determine a variety of details about a connection, including its type, its speed, its reliability or error correction methods. Some network protocols require specific handshake processes, or request mechanisms to be satisfied before a connection can support a high bandwidth transmission such as that required by VTC. Traditionally, the VTC data is paused or alternatively, the VTC is degraded until a suitable network connection is available.

The present invention proposes an improvement to transferring a video and/or audio stream during a Video Telephony Communication that ensures a smooth transition from one Endpoint to the next. This is accomplished by identifying potential Endpoints a VTC is to be transferred to, based on data monitored in the Communication System. Once potential Endpoints are identified, new connections to those potential Endpoints are made and configured for high bandwidth transmission in parallel with the existing VTC, and without disrupting the existing VTC. Once the appropriate connections are in place to support a VTC, the existing VTC is transferred to the new Endpoint seamlessly, as there is no overhead that is incurred as they have already been incurred, and resumes, only after sufficient data has been buffered at the new endpoint.

In an embodiment of transferring a video/audio stream seamlessly, a potential list of Endpoints to transfer to is determined, by leveraging the additional context provided by the data collected by the Communication System. From this gathered data, in particular data that indicates the proximity of users and Endpoints, the Decision Unit can infer the Endpoints that the user is likely to transfer the VTC to. These criteria may be based on proximity of Endpoints, a user's location, or what Endpoints a User owns, or as is determined by Activation Events (as further described in the Decision Unit).

As it pertains to transferring streams, the Communication System has inferred a shortlist of possible Endpoints that a VTC can be transferred to. Thus, the VOIPS can actively establish connections to only these potential Endpoints and concurrently transmit video and/or audio stream data to such Endpoints. By actively establishing a connection with the intended Endpoint, significant overheard, in both time and data from the act of establishing a connection, is avoided. This is not possible, or would be very inefficient without the additional knowledge provided by the data gathering within the Communication System, particularly around proximities of Endpoints as it may be unrealistic, or highly inefficient to transmit data to a multitude of Endpoints, instead of a subset of potential Endpoints, dynamically identified by the Communication System based on data monitored

Once a connection is established, the VOIPS can configure and condition the connection for high bandwidth transmission. Once a user initiates the transfer, to an Endpoint that already has an established connection to the VOIPS, the Endpoint only has to signal to the VOIPS to enable the intended Endpoint to be the new Endpoint to connect in the existing VTC. A smooth transition occurs as the new Endpoint does not have to expend additional time establishing a connection to continue the VTC and video and/or audio data can be immediately transmitted to the new Endpoint via an appropriately configured network connection.

The VOIPS and Endpoints describe above comprise of video telephony communication systems common in the state of the art, and examples of such systems are Facetime, Skype and cellular voice calls. The present invention does implement a video telephony system but the present invention can be appreciated so long as a system that enables communication is available. New forms of video telephony may be available that may deviate from that which is described hereinbefore and as such, it can be understood by PHOSITA that future communication systems and methods can be utilized in the same manner as the video telephony systems disclosed herein.

### External Data Interface and Storage (EDIS)

The Communication System of the present invention can interface with external computer systems to leverage additional data and information available on those systems. For the purpose of describing the present invention, such computer systems are to be referred to as External Data Sources.

Many computer systems provide application programmable interfaces (APIs) to interact with other computer systems, using said APIs to leverage functionalities or data available within this a computer system. EDIS establishes connections to the respective External Data Sources using said APIs, via software components referred to as API Connectors. API Connectors are software components that implement the corresponding protocols for the API, specific to an External Data Source.

In the foregoing manner, EDIS queries applicable External Data Sources and optionally, stores data from said sources. This data is made available to the Data Sources Hub of the Communication Control Server, to be later analyzed.

In an embodiment of the invention, the EDIS can be implemented with an External Data Source Management (EDSM) that allows for the creation, modification or removal of API Connectors that interfaces with the various APIs of a multitude of External Data Sources. Additional API Connectors may be implemented with software code into software packages, by users or by implementers of the Communication System. In implementing API Connectors, the software packages will detail what data is queried, using the appropriate APIs for the specific EDS. Each API Connector may be integrated with the EDIS by registering the API Component with EDIS in an API Connectors directory. This ensures that when EDIS queries data, API Connectors registered as active in the directory are identified and their software packages executed to gather data.

An external computer system is an External Data Source so long as the external computer system provides data that is relevant to the users and state of the Communication System, such that said data can be effectively utilized in an Activation Event.

Given the foregoing scope, a myriad of computer systems can be used as External Data Sources. In one embodiment, enterprise computer systems that drive communication between employees can be External Data Sources. These types of systems provide data on a user's communication pattern, including the people they communicate with, the frequency of communication and potentially the context of said communication.

For example, an email server can act as an External Data Source providing a user's contacts, pattern of communication (e.g. who, when, how often). In another example, a calendar scheduling server can act as an EDS, providing data on a user's communication pattern in the future. In another example, an enterprise social network (such as a product called Yammer) can act as an EDS. Such systems often form functional groups that users can be a member of. This provides further context and data on a user's contacts and can show that certain contacts may be more relevant because users are members of similar groups. In yet another example, a corporate informational technology user management system (such as Microsoft Active Directory) can be used as an EDS as such user management systems provide further context to a user's contacts and role within an enterprise, including permissions on what enterprise resources (such as other users, or a video telephony communication endpoint) a user can and cannot access.

Different types of data can be gathered, depending on the types of External Data Stores. In a previous example, an email server can be used as an EDS to provide a list of contacts and communication pattern. Further data can be gathered from this EDS such as the text content of emails. By analyzing full text contents of emails, additional metadata can be ascertained, such as the sentiment of the email, topics and urgency. This type of operation is more complex than simply querying and retrieving available data and requires additional analysis of a data set (in this case, text contents of emails). Some computer systems accomplish this additional analysis, in which case, the metadata can be treated as basic data and gathered by the EDIS. Alternatively, this additional analysis can be completed by the Communication System's Data Analyzer in the Communication Control Server. In such a case, only basic data (in the example, emails) is gathered by EDIS, processed by the Decision Unit and any metadata gathered can then be stored in the Communication Control Server Database, to be leveraged in future analysis completed by the Decision Unit.

### Communication Control Server (CCS)

The Communication Control Server manages the communication between Endpoints and is responsible for providing instructions to the various other components of the communication system, by collecting and analyzing the data available to the Communication System.

The CCS comprises of a Data Sources Hub (DSH), a Decision Unit (DU), a CCS Output, an Activation Events Database (AED) and a CCS Database (CCSD). Said software system and functions work in conjunction to, gather data from components of the communication system, analyze said collected data to identify the state of the system and select the appropriate action for each state.

Further detail of each of the aforementioned components of the Communication System is provided herein.

In one embodiment, the CCS is a centralized component within the Communication System wherein decisions made for the Communication System is made by the same Decision Unit. In this embodiment, data from the various components of the Communication System is gathered at the CCS to be analyzed and subsequently to drive decisions.

In another embodiment, the CCS can be a distributed one, wherein various components in the Communication System can have its own implementation of the CCS, including a Data Sources Hub, a Decision Unit, an Activation Events Database and a CCS Database. In this embodiment, each CCS implementation may have responsibility to the component in which it resides. The DU in each CCS implementation makes decisions related to the operation of the relevant component, rather than the overall Communication System. In this embodiment, the Activation Events Database may only store information such as actions that are only applicable to the specific component. Likewise, the CCS Database may only store data and information relevant to the operation of the specific component.

In another embodiment, a hybrid model may be used, wherein there is both a centralized CCS and an implementation of a CCS on various components within the Communication System. These CCS may be in constant contact to manage each CCS's responsibility. Thus, CCS on specific components may look for specific Activation Events with actions specific to the CCS, while concurrently, the centralized CCS continues to gather data from all components of the System and detects and instructs actions for all components.

For example, a centralized CCS may detect states for multiple components and make decision on the actions to be taken for multiple components. A centralized CCS may evaluate the input from one Endpoint, and decide to take action upon another component of the Communication System. An example of a hybrid approach may involve the Endpoint CCS to detect users' faces and upon a face being present, capture and transmit audio data in a Video Telephony Call. In this case, the data, the decision and the action pertains to the Endpoint. At the same time, the Endpoint can transmit data related to the Endpoint to the central CCS, where it may be combined with other data points, such as the presence of another user at another data point, and a specific time of day, which collectively, allows the central CCS to recognize patterns and adapt to usage patterns.

### Data Sources Hub

The Data Sources Hub is responsible for querying and acquiring data from components within the communication system. The DSH establishes connections to Endpoints and the VOIPS to query said components for data needed for the operation of the CCS. The DSH can query the aforementioned data sources for updated data, or alternatively, the data sources can send updated data to the DSH.

The DSH also queries the External Data Interface and Storage to gather data from data sources external to the Communication System.

The DSH also queries and accesses data specific to the Communication Control Server, stored in the CCS Database.

The DSH formats the acquired data into a form to be interpreted and processed by the Decision Unit.

### Decision Unit

Artificial intelligence concerns construction of intelligent machines and software that is capable of reasoning, knowing, learning, perceiving and acting, often driven by the data of a system. Within the context of the present invention, a plurality of sensors/probes monitor data points and then such data points are analyzed to determine a state of each endpoint, to correlate the state of each endpoint with at least one pre-identified state, and to compare the state of endpoint to at least one pre-identified state therein to recognize if an activation event is triggered. If an activation event is triggered, an action related to the pre-identified state is taken. Within these steps, data is analyzed and in a preferred form, machine learning, a subset of artificial intelligence is used to analyze the data points to determine a state of each endpoint and to recognize if the activation event is triggered.

The Decision Unit (DU) is an intelligent system that perceives the state of the Communication System through available data provided by the DSH and determines the appropriate action that needs to be taken by components in the Communication System, in order to maintain proper operation of the Communication System, based on the state of the Communication System and the criteria provided by the Activation Event Database. The intelligence system within the DU can be implemented with a variety of methods commonly used in the field of computer programming, machine learning or artificial intelligence. Each method has their corresponding advantages, disadvantages or limitations, and varies from primitive to highly sophisticated and robust processes. As such, depending on the method implemented, the capability of the DU varies accordingly. Some methods may be limited by the number or degree of complexity of the data points it is able to interpret. Other methods may be limited by the number of states (of the Communication System) it is able to identify, and thus, determine and appropriate action for.

The following section provides a few embodiments, using varying intelligence methods to provide varying capabilities.

In one embodiment, a simple method of conditional programming common in the practice of computer science is utilized to provide intelligence to the DU. In conditional programming, logical operators are used to construct conditions for the data monitored that when met, triggers a corresponding action. As it pertains to the Communication System, the conditions may be based on the state, or value of data points and the corresponding action may reflect actions available in the Communication System such as initiating a Video Telephony Communication or modifying the audio stream. For example, a condition may be constructed to capture the state where an Endpoint's detects the presence of a user's face and the corresponding action requires the Endpoint to begin capture and transmission of audio data in an existing VTC. In operation, the DU will receive the data from the Endpoint regarding the presence of a user's face and the condition is thus met. Consequently, the DU will signal for the appropriate action, in this case, instructing the Endpoint to begin capture and transmission of audio data.

A similar but more sophisticated method is commonly referred to as expert systems in the field of artificial intelligence. This method leverages a set of IF-THEN rules to form a knowledge base. Said knowledge base is accessed by an inference engine to apply the rules of the knowledge base to deduce actions or new rules. In this embodiment, the knowledge base is represented by the Activation Event Database in FIG. 3. This method provides more structure to the rule-based intelligence. The rules created within the knowledge base may be simple conditions or may contain compound conditions involving logic operators. In the same example as above, instead of simply using one data point (the presence of a user's face) as the condition, a more advanced condition can be formed by combining the existing condition with, for example, the data indicating there is a high level of activity at the corresponding Endpoint participating in the existing VTC.

Beyond accommodating more data points, the aforementioned method can also utilize an inference engine that applies differing types of logic that may make the DU more robust in the states it is able to detect. Some of these types of logic may include, modal logic, fuzzy logic and probabilistic logic. The inference engine can also be hard-coded to execute specific actions given a certain state of data points.

The above inference engine can also leverage methods in artificial intelligence often referred to as probabilistic methods to determine the appropriate action, given the state of the system. In a probabilistic method, mathematical processes can be leveraged to allow for further flexibility in how the state of the system drives the selection of the appropriate action.

Bayesian networks are examples of such probabilistic methods that could be utilized in an embodiment of the present invention. Datapoints in the Communication System can be matched with nodes, and conditional relationships between Datapoints can be matched with edges within a Bayesian network. Given a Bayesian network, well-known Bayesian methods to calculate the probability of the most likely system states, such that the inference can engine can determine the most appropriate action.

The previous methods have certain limitations that make them non-adaptive, and thus, unsuitable to changing conditions. It may also limit it from detecting more obscure states that may not initially be known, but determined through historical patterns in the monitored data. As such, and in another embodiment, the DU utilizes methods from the branch of artificial intelligence commonly known as machine learning, wherein the intelligence system can be adaptive to new scenarios without being explicitly programmed. This is possible through deep analysis of available data to recognize pattern within said data. This deep analysis is commonly known as data-mining. Numerous approaches within the field of machine learning is available to achieve the aforementioned, including using supervised learning algorithms and tools such as support vector machines, naïve Bayesian classifier and artificial neural network, or unsupervised learning approaches such as using hidden Markov models or reinforced learning methods.

In this embodiment, the DU is capable of recognizing new patterns in the usage of the Communication System and to adapt itself to recognizing these new states of the Communication System, forming its own set of conditions that must be met, and the appropriate action that meeting of said conditions triggers.

In a simple example, two Endpoints are used over a period of time to carry out Video Telephony Communication. The DU, over this period of time, has monitored the available data, including potentially, the time of day VTC is initiated, the length of said VTC and the identified participants of said VTC. Over time, the DU recognizes that a pattern involving the aforementioned data set—that two identified individuals routinely conduct VTC at a specific time, on a specific day of the week, on a weekly basis. The process of data-mining has revealed this pattern and then DU, leveraging machine learning techniques, identifies this pattern and adapts itself to detect this state in the future and take appropriate action—in this case, initiating a VTC at the suitable time involving the relevant participants.

It is important to note that the aforementioned artificial intelligence methods are by no means intended to limit the methods that can be utilized. A person skilled in the art will recognize the objectives of the methods in the field of artificial intelligence in leveraging data sets, and determining actions to maintain control of the system based on the state of said data sets. It is not the scope of this invention to describe novel methods of artificial intelligence. However, novel methods of artificial intelligence may become available and may be suitable for use in the Decision Unit, provided that it achieves the aforementioned goals of the field of artificial intelligence. Furthermore, as one skilled in the art of artificial intelligence can appreciate, the mentioned methods in the foregoing section are a subset of methods and tools available to computer scientists to achieve artificial intelligence in systems. Thus, computer scientists can also use a combination of the aforementioned methods to achieve more efficient analysis processes, accuracy or flexibility in the intelligence system.

### Activation Event Database

The Activation Event Database stores and makes available Activation Events that are used by the DU to identify the state of the Communication System and to determine the appropriate action that is required.

Activation Events are computer records that define the relationship between available actions for the Communication System and the data gathered. It comprises of a set of conditions and optionally, a corresponding action that is taken, upon satisfaction of said set of conditions. The set of conditions may comprise of parameters appropriate for the data gathered from the DSH. Said parameters are dependent on the type of data in question and may be numeric, Boolean, state-based or text. Said sets of conditions may also be constructed by combining a multitude of parameters, potentially from a multitude of data sources, using logical operators Data that makes up a set of conditions can also be gathered and evaluated over time. In such a case, data can be queried from different points in time, but are considered together at a later time to determine the state of the system. For example, a data from time a, can be considered alongside data from time b, and the current data, and then combined with other data sources to form one set of conditions.

Activation Events may comprise of corresponding actions that the DU can execute itself, or instruct other components of the Communication System to apply, upon satisfaction of a set of conditions defined in the same Activation Event. Said actions typically are specific to each software component and relevant to their function within the Communication System. Actions may include, without limitation, updating CCS Data for a specific user, instructing VOIPS to initiate Video Telephony Communication, or for the CCS to send information or device configuration data to an Endpoint. Actions may also include sending of data to External Sources connected to the Communication System.

In one embodiment of the invention, the Activation Event Database can be pre-populated with Activation Events in the process of implementing the invention. In another embodiment of the invention, the Activation Event Database can be updated during the operation of the Communication System by the implementer of the invention, after the Communication System has already been deployed. In yet another embodiment of the invention, a system can be available to interface with the Activation Event Database to create, modify and update the contents of the database and the Activation Events therein. Said system can provide a user interface to allow the aforementioned actions to be completed by a user of the Communication System. In such an embodiment, such system can allow users of the Communication System to create new Activation Events or modify existing Activation Events to accommodate for changes in the Communication System, such as the addition of new External Data Sources.

CCS Database

The CCS Database receives, stores and manages data specific to the operation of the Communication Control Server within the Communication System. This category of data provides information about the state of the CCS (including state, condition) and associated data about interaction between various components of the Communication System with the CCS.

The CCS Database is queried by the DSH to provide data to be analyzed by the DU. The CCS Database can also be utilized to store and collect data over time from the DSH. The development of a historical database of data allows for more extensive data to be utilized in developing Activation Events. For example, an Activation Event can monitor not only different data sources, but also changes over time from data sources as additional triggers.

In Operation:

With the various components of the components of the Communication System described, the operation of the Communication System in a preferred embodiment can be appreciated through several non-limiting examples.

### Intelligent Auto-Connect Driven by Collected Activity Data at Endpoint

In an exemplary scenario, a Communication System, as described in FIG. 1, is set up in an office environment, with Endpoint A, B and C each at a different office location. In this exemplary scenario, an Activation Event involves data from motion sensors, and microphones from the Endpoints and the corresponding action is automatically connecting Endpoints in Video Telephony Communication.

At all times, each Endpoint is gathering data at its respective locations on the presence of users. Each Endpoint is equipped with an image sensor and a sound sensor to detect faces, levels of movement, and noise, as described earlier on. Data gathered from these sensors are evaluated against parameters to determine the presence of users, or level of user activity at an Endpoint.

For example, initially, Endpoint A detects motion at its location and following that, detects the presence of two user's face at its location, as well as a medium level of noise. At the same time, Endpoint B does not detect any faces, but do detect on-going motion at its location and a high level of noise At Endpoint C, no face, motion or noise is detected.

Each Endpoint stores this data (presence of face, movement or noise, or lack thereof) and when queried by the Data Sources Hub in the Communication Control Server, transmits this data to the DSH. The DSH collects this data, and formats it for the Decision Unit. The Decision Unit compares this data with Activation Events in the Activation Event Database. The aforementioned Activation Event, involving the automatically connecting of Endpoints, is compared to the data submitted by the DSH. The DU, in light of the relevant Activation Event, concludes that the state of the system is such that there is user activity at Endpoints A and B, and no Endpoints at C.

Therefore, in accordance with the corresponding action on the Activation Event, instructs the VOIPS to automatically connect Endpoint A and Endpoint B.

The VOIPS proceeds to signal the respective Endpoints to connect, transmitting to them the necessary unique identifiers such that the Endpoints can establish a connection between them. Once a connection is established, voice and video data can be transferred and Endpoint A and B are in a VTC.

At a later time, notifiers/sensors/probes at Endpoint C may begin to detect an increase in motion, noise or begin to detect presence of users' faces, and Endpoint A's detected activity decreases. Operating in the same manner as Endpoint A initially, Endpoint C can detect these triggers and passes them onto the DSH when queried. The DU, operating in the same manner and considering the same Activation Event, instructs the VOIPS to then connect Endpoint C with Endpoint B.

### Face-Detection Driven Audio

In this exemplary scenario, a Communication System, as described in FIG. 1, is set up in an office environment, with Endpoint A and B each at a different office location. In this exemplary scenario, an Activation Event involves data indicating the presence of a user and an intent to speak, and the corresponding action is controlling the activation of the microphone. Specifically, the Activation Event is such that the microphone at an Endpoint is unmuted and audio data is transmitted, only when a user is detected to be present and shows an intent to speak at said Endpoint.

Initially, Endpoint A and Endpoint B are connected in a Video Telephony Communication. In a traditional VTC, both video and audio data is always captured and transmitted for the duration of the VTC. Within the scope of the invention, the VTC only transmits the video data and the microphone is initially muted and no audio data is exchanged, as no users are present at either Endpoints. Both Endpoints constantly detect the presence of a user in front of the Endpoint by utilizing camera and executing the appropriate software algorithms to detect the presence of a user's face. In addition, the software algorithm further analyzes the captured image data and identifies additional information such as the orientation of the user's face, such as whether the user is facing the Endpoint, or looking away. The aforementioned data is stored in the Endpoint until queried by the Data Source Hub.

At a later time, a user becomes present at Endpoint A. The camera at Endpoint A captures the user and the software algorithm is executed and identifies the presence of a face. In addition, the algorithm identifies that the user is facing the Endpoint. This information is pushed to the Communication Control Server to be analyzed by the Decision Unit. The information is interpreted in accordance with the Activation Event and fulfills the conditions set out in the Activation Event. The corresponding action is to enable the microphone and begin transmitting audio data. This instruction is transmitted to Endpoint A, where the microphone is unmuted and audio data begins to be transmitted to Endpoint B.

In another embodiment of the above scenario, the analysis executed by the Decision Unit may be implemented directly on the Endpoint, together with the conditions of the Activation Event. In such a case, Endpoint A is capable of interpreting the information, in accordance to the conditions set out in the Activation Event, and take the appropriate action.

The communication system is intended to advantageously support video conferencing, particularly:
Communicating intra-family (between members of a home)
Communicating inter-family (between members of extended family's homes)
Communicating close-friends (between members of a friend network)
Communicating anonymously (between anyone)
Communicating intra company (between members of colleagues at work)
Communicating inter company (between members of the company)
Communicating extra company (between members of other companies)

While it is clear that this system has wide ranging commercial and business applications, is also particularly useful for “family” communications, home security and home monitoring (for example, as nanny-cam or to watch pets while at away from home).

During a video communication event, comprising one or more video scenes, a system typically transmits both local video signals and local audio data signals to the remote server and receives remote video and remote audio signals from the remote server.

### Periodic Snapshot of Portal View

In another exemplary example of the Communication System in operation, images are captured at a multitude of Endpoints and sent to each Endpoint to allow users to be aware of the activities at each Endpoint, without the need for Video Telephony Communication.

Traditionally, in order for two users to be able to see the activities that are ongoing at a location, VTC would have to be established and video data has to be exchanged and rendered on a screen to convey the activity. This not only consumes significant amount of bandwidth in the network to transmit the video data, but having an ongoing VTC also can be distracting to some users. Alternatively, indicators to provide context about a user's presence at an Endpoint have traditionally been used. This included status messages or colored indicators to indicate a user's availability, such as busy, online or away. Such indicators are often insufficient in fully representing the availability of the user or is not accurate as it sometimes rely on the user to manually input the setting. In this scenario, the present invention is used to alleviate all of the aforementioned concerns.

Initially, Endpoint A, B and C are all part of the Communication System. Each Endpoint has software that shows a dashboard containing information about the other Endpoints, including the Endpoints name and a user-actionable button that can initiate VTC with any of the other Endpoints. The dashboard also uses an image to represent each Endpoint in the list, hereby referred to as the Endpoint avatar. In this example, the present invention enables the Endpoint avatar to be more than a static image, but instead a dynamic image that is driven by the data points collected within the Communication System to provide further context of the activities at an Endpoint than a static image.

In one scenario, the Endpoint avatar can comprise of images captured by the image-capture device at each Endpoint to give other users a view of the activities at each Endpoint. The Endpoint avatar may be updated periodically and such changes pushed the other Endpoints as part of the operation of the Communication System. In such a case, the image-capture device captures images at an Endpoint after the pre-determined amount of time has elapsed. The DSH of the Communication System, again upon the expiration of the same pre-determined amount of time, queries the Endpoint for an updated image. The image is passed to the DU, wherein an Activation Event that details upon the expiration of the same pre-determined amount of time, that the new image is updated throughout the other Endpoints within the Communication System.

In another scenario, the Endpoint may leverage the other notifiers/sensors/probes available on said Endpoint to determine changes in activity at the Endpoint such that if changes in activity is detected from said notifiers/sensors/probes, this triggers an Activation Event and a new image is captured for use as the Endpoint avatar. For example, notifiers/sensors/probes can capture images, and said images can be processed to detect motion at an Endpoint. Should motion be detected, this triggers an updated image to be captured, then transmitted and updated to the remaining Endpoints.

In another scenario, the Endpoints within the Communication System can establish a constant connection with each other. This is the same connection that would be established should VTC be occurring. However, instead of constantly transmitting audio and video data through this connection, both Endpoints leverages the connection to transmit a fraction of the video data that would be transmitted in a typical VTC. For example, the Endpoint can transfer only 0.5 frames (captured images) per second, rather than a typical 22 frames per second in a VTC. The transmitted frames can be used and updated as the Endpoint avatars. Users of the Endpoints can still leverage the dynamic nature of the Endpoint avatar to gain context of the activities at any given Endpoint. This significantly decreases the amount of bandwidth consumed in transmitting video data.

Furthermore, should a VTC be initiated between any of the foregoing Endpoints, no additional connection needs to be established. Instead, both Endpoints begin to transmit more image frames, such that it matches the typical throughput of a VTC. This provides a seamless transition from an asynchronous form of communication (periodic update of images of users at an Endpoint) to a synchronous form of communication (Video Telephony Communication between two Endpoints).

To this end, the present invention further provides a method of monitoring activity at least two endpoints and wherein images are captured at the endpoints and are available to the other endpoints, without the need for Video Telephony Communication (VTC), wherein the endpoints are part of a communication system which comprises:

a) collecting data points at each endpoint and using that data points to create a dynamically changing image/avatar of the endpoint, based on activities occurring at the endpoint; and
b) making the dynamically changing image/avatar of the endpoint accessible to other endpoints, (preferably but not exclusively via a dashboard at each end endpoint), wherein there is additionally provided a user-actionable means to initiate VTC with any of the other endpoints;

Preferably, the method additionally comprises queuing the possible alteration of the dynamically changing image/avatar after a pre-determined elapsed time. Preferably; the method additionally comprises determining if the dynamically changing image/avatar and any updates thereto trigger an activation event. Preferably, if activation events are triggered, the images/avatars are updated with captured activity at the endpoint

Within this context, activation events comprise one or more of:

1) elapsed time based as the data points captured at endpoint
2) combination of data received from probes/notifiers/sensors etc at endpoint; and
3) motion.

Preferably, the dynamically changing image/avatar of the endpoint is a plurality of images of activities occurring at the endpoint. Preferably, the communication system prompts the endpoint for an updated image/avatar if an updated image/avatar has not been provided at the elapse of pre-determined time. Preferably, the activation event is triggered by the elapse of the pre-determined time and wherein no updated image/avatar was provided. Preferably, the activation event is triggered by conveyance of a new updated image/avatar. Preferably, the activation event is triggered by changes in activity at an endpoint identified by data points acquired by one or more notifiers/sensors/probes. Preferably, the activation event is triggered by changes in activity at an endpoint identified by data points acquired by one or more notifiers/sensors/probes detecting motion at an endpoint. Preferably, a notified/sensor/probe detects motion at an endpoint and this triggers an updated image/avatar to be captured, then transmitted and updated to the remaining endpoints. Preferably, the method additionally comprises the step of conveying VTC data between the endpoints without the need for further connection therein providing a transition from an asynchronous form of communication (periodic update of images of users at an endpoint) to a synchronous form of communication (Video Telephony Communication between two endpoints).

### Calendar Driven Contact List

The Communication System in the present invention is able to monitor data points from external computer systems through EDIS. The following exemplary scenario demonstrates how such external data points can enable actions to be taken within the Communication System.

In this example, the external computer system being monitored is a user's calendar system in which the details (meeting name, attendees, time) of the user's future appointments are stored. The EDIS of the Communication System has the appropriate API Connectors to access and query the appointment data in the calendaring system.

At each Endpoint of the Communication System, there is a set of other Endpoints that can be reached to initiate VTC. Said set may arrange Endpoints in a grid manner, or a vertical list manner. The Communication System can leverage data points such as the time of the day at a user's Endpoint, and the user's upcoming calendar appointments to augment the way in which the set of available Endpoints are arranged to the user.

In operation, the Communication System queries the Endpoint for the time of the day and as part of its analysis, compares it to the starting times of the user's upcoming appointment stored within the user's calendaring system. The DU within the Communication System can leverage a set of Activation Events that instructs a different arrangement, depending on how much time remains before the start of the next appointment.

For example, an upcoming appointment for a user at Endpoint A is to commence in 30 minutes. At this time, the DU may determine that the set of connectable Endpoints visible to the user at Endpoint A is arranged in a typical grid fashion, with three contacts per row. At a later time, the same upcoming appointment is to commence in 15 minutes, AT this time, the DU may adhere to another Activation Event that instructs the set of available contact is to be amended such that the attendees of the upcoming appointment are prioritized in the grid. This may include arranging them earlier in order, or allowing a larger icon to represent for those attendees, than other Endpoints. Yet another Activation Event can instruct that at the time the meeting is to commence, the contact list at Endpoint A shows only representations of the attendees for the meeting and all other contacts are hidden.

In this way, the external data (calendar event) is leveraged with data (time of day) at an Endpoint, to remind the user an upcoming event is occurring and to highlight the attendees of said event. It also allows the system to present a more user-friendly interface for the user as the user does not have to search through a potentially long list of contacts to initiate the event.

### Meeting Queue

The Communication System of the present invention can also leverage the monitored data points from Endpoints, in combination with data points specific to the operation of the Communication System to intelligently connect users in synchronous forms of communication.

In an exemplary scenario, the Communication System provides an opportunity for users to send Call Requests with other users, indicating a desire to communicate over VTC. These Call Requests may comprise of the originating requester, the recipient (callee) and optionally, a short character-limited message from the requester to the recipient. Call Requests are then stored within the Communication System and handled as additional data point that can be leveraged by Activation Events. As such, Activation Events can be provisioned to leverage the existence of a Call Request, in addition to other conditions (such as presence/availability of user) to initiate VTC.

Most importantly, Call Requests need not contain temporary data such as a proposed time, or availability in the future. Often users of communication systems struggle to find common availability but the present invention endeavors to alleviate this problem by leveraging data points in the Communication System.

In operation, two users (Users A, User B) are present at two Endpoints (Endpoint A, Endpoint B, respectively), both Endpoints being part of the Communication System. User A attempts to initiate VTC with User B, but User B either declines or is unavailable. User A is presented with the option to make a Call Request, indicating User A's desire to communicate with User B. Take note that User A does not need to indicate to User B specific suggestions for future times to speak; however, User A may give broad limitations, such as by the end of the day) in the message body to User B.

At a later time, both User A and User B is available at Endpoint A and Endpoint B respectively. Both Endpoints detect the presence of the respective users by detecting and identifying the faces as User A and B. This presence data is queried by the DSH in the CCS and analyzed by the DU. The DSH also queries the CCS Database for data points that are specific to the operation of the Communication System. There it identifies that an outstanding Call Request is present between User A and User B. The DU is able to reason, given the data points, that User A intends to speak with User B, and at this time, both User A and User B are present and available. The DU takes note of this and instructs both Endpoints to initiate VTC.

In another embodiment, the message body of a Call Request can act as a data point to the Communication System and provide additional data, pertaining to the intent of Call Request. Given this, the Communication System can leverage this additional data to determine the appropriate action that needs to be taken. For example, if a Call Request message body indicates the broad requirement that communication needs to take place by the end of the day, the Communication System can process the message body to reason the additional temporal requirement. It can then leverage this piece of data point to actively seek mutually available opportunities for the relevant users, or prioritize any communication between relevant users to fulfill the Call Request.

In another embodiment, a user can initiate a mode within Communication System such that an Endpoint automatically connects the user with other users who have provided Call Requests in a sequence of VTC, for a duration of time, or until all Call Requests have been responded to. For example, User A, C and D have all made Call Requests to User B. User B, upon returning from a meeting can initiate a mode on Endpoint B that automatically connects User B with those that intend to speak to him, and are available. The Communication System may connect User B to Users A initially, then C (provided both are present and available) but not User D, because User D is unavailable.

The above exemplary scenario is unique in that it does not rely on a pre-existing meeting appointment to initiate communication. Users did not have to provide availability or suggest potential times for communication. Users simply have to indicate an intent to communicate and the Communication System leverages the data points monitored by the Communication System to find the most appropriate time.

### Video Caller ID

The Communication System of the present invention can also initiate VTC in such a way that is unintrusive to the users involved. In one exemplary scenario, the Communication System can initiate a VTC between two users by selectively transmitting video and audio data from the caller to the callee, while the VTC is being established.

In any communication method where a caller attempts to initiate VTC by calling the callee, there may be a phase in time when the callee needs to accept an incoming attempt from the caller. In such methods, the caller is prepared to partake in VTC as the caller initiated communication. However, the callee may often be unprepared and caught off-guard.

In operation, when User A calls User B, the Endpoint where User B is reachable will be notified and may make visual and/or audio notifications to alert User B. User B can then be presented with an interface to accept or decline the communication request from User A. While presented with this interface, additional context can be provided to User B on the caller by presenting video-data from the Endpoint on which User A is initiating the communication. Thus, User B sees a live video representation of User A and can use additional context to accept or decline the call.

### Applications on Mobile Devices

Mobile devices and networking technologies have transformed many important aspects of everyday life. Mobile devices, such as smart phones, other cell phones, personal digital assistants, enterprise digital assistants, tablets and the like, have become a daily necessity rather than a luxury, communication tool, and/or entertainment center, providing individuals with tools to manage and perform work functions such as reading and/or writing emails, setting up calendaring events such as meetings, providing games and entertainment aspects, and/or store records and images in a permanent and reliable medium. The internet has provided users with virtually unlimited access to remote systems, information and associated applications.

As mobile devices and networking technologies have become robust, secure and reliable, ever more consumers, wholesalers, retailers, entrepreneurs, educational institutions, advocacy groups and the like are shifting paradigms and employing the these technologies to undertake business and create opportunities for meaningful engagement with users. It is within the backdrop that the system and method of the present invention was developed.

Applications may be pre-installed on mobile devices during manufacture or can be downloaded by users/customers from various mobile software distribution platforms, or web applications delivered over, for example, HTTP which use server-side or client-side processing (for example, JavaScript) to provide an “application-like” experience within a Web browser. Within the scope of the present invention, users of devices download an application to enable the video/audio engagement, as described herein (the “Perch” App). Most preferably, a user with an iOS device like an iPhone, attaches it to his/her wall and starts up the Perch app.

To install a mobile device application, a user will typically either drag and drop an icon to the device or click a button to agree to the installation. Uninstalling one is also straightforward, and typically involves deleting or dragging the icon away from the device. When a user uninstalls a mobile device application, he or she may also lose all the data relating to it because, in many cases, it is not stored separately. The number of applications that can be installed on a single phone depends on the phone's memory.

Using the system and method of the present invention, no special equipment is required and implementation is as simple as loading an application onto each of the devices. In fact, there is no need for wait times for devices to “power up” or to push buttons on screens or keyboard, the devices within the system are ready for input at any time.

In a preferred form, the present invention uses computer vision and motion detection to determine if there is a user in front of the camera and wishes to talk to people at a remote location. In most cases, the camera is within a device mounted at a fixed location.

In a preferred form, users of authorized mobile devices can control mounted devices with his/her Smartphone, iPod or android type music players. One such control is to be able to tune it into another mounted device in another location. Once tuned in, it stays tuned in until changed by any authorized user. The microphone is muted on both cameras by default, but the microphone of each respective side is automatically unmuted when the camera detects a face. This allows for planned, or more uniquely, free form ad hoc conversations to take place between two distinct locations without the user needing to press any buttons at all. The user, however, can change the location of the screen with their computing device (computer, smartphone, tablet, media player).

With the scope of the present invention, one can automatically switch the video and audio capture device (which could be different devices) as the target moves around the environment by use of audio triangulation and computer vision.

With the scope of the present invention, activation events may be based on certain audible or motion based gestures, such as open and close the drapes, turn on/off music, turn up/down the volume of music, or any other action programmed into the device. In some aspects, this feature would integrate with home automation products, for example, a Control4 system or Next thermostat.

### Further Aspects of the Invention:

The present invention provides, in another aspect a method and system of video and/or audio communication between at least two and optionally a plurality of endpoints, comprising:
1) gathering data from a multitude of data sources related to the communication system or the user of the communication system;
2) analyzing the collected data to determine the state of the endpoint, in accordance with previously identified states;
3) taking pre-determined action within the communication system attributed to the identified state.

The present invention provides, in another aspect, a method and system of video and/or audio communication between at least two and optionally a plurality of locations, wherein such communication is dynamically and automatically toggled, as appropriate, between a synchronous communication flow and an asynchronous communication flow. By way of a plurality of pre-assigned activation triggers at any image/audio capture location, data is automatically transmitted to a server wherein it is either stored for subsequent viewing/listening by one or more intended recipients or such data is streamed live to one or more intended recipients. Activation triggers prompt data capture and communication between a server and devices at two or more locations, said direct the server in regard to one or more notifications to be conveyed to devices at the locations.

The present invention provides, in another aspect, a system for automatically toggling synchronous and asynchronous communications between at least two users, at two locations which comprises:
a) at least one video and/or audio capture device at a first location which acquires and synchronously and/or asynchronously transmits audio and/or video data from a first user via a server to a second user;
b) at least one video and/or audio capture device at a second location which acquires and synchronously and/or asynchronously transmits audio and/or video data from the second user via a server to the first user;
c) a computer processor operative with the video and/or audio capture device at the first location, which comprises at least one of the following: a motion detection means, a facial detection means and an environment change means, one or more of which enables triggering of an activation event by which audio and/or video data is transmitted from the first location to the server;
d) a computer processor operative with the video and/or audio capture device at the second location;
e) at least one video and/or audio capture device at the first location which receives, synchronously and/or asynchronously, audio and/or video data from the second user, via the server, after an activation event;
f) at least one video and/or audio capture device at the second location which receives, synchronously and/or asynchronously, audio and/or video data from the first user, via the server, after an activation event; and
g) the server, which undertakes one or more of the following actions: confirming secure communications between the video and/or audio capture devices at the first location and the second location, receiving audio and/or video data from the first user and the second user, transmitting a notification to the video and/or audio capture device at the second location after an activation event, transmitting video and/or audio data to the video and/or audio capture device at the second location after an activation event; transmitting video and/or audio data to the video from the second location to the video and/or audio capture device at the first location; recording and storing video and/or audio data for subsequent transmittal to the video and/or audio capture device at the first and/or second location.

The present invention further provides, in another aspect, a computer implemented method for automatically toggling synchronous and asynchronous communications between at least two users, at two locations which comprises:
a) upon the occurrence of an activation event at a first location, acquiring and synchronously and/or asynchronously transmitting audio and/or video data from a first user at the first location to a server;
b) confirming secure communications between the video and/or audio capture device at the first location and a device at a second location;
c) transmitting notice from the server to the device at the second location upon occurrence of an activation event;
d) transmitting via the server audio and/or video data from the first user to the device at the second location either “live” or in archived form; and
e) transmitting via the server audio and/or video data from a device at the second location to the device at the first location.

The present invention provides, in another aspect, a machine readable non-transitory storage medium that stores executable instructions for automatically toggling synchronous and asynchronous communications between at least two users, at two locations which comprises:
a) upon the occurrence of an activation event at a first location, acquiring and synchronously and/or asynchronously transmitting audio and/or video data from a first user at the first location to a server;
b) confirming secure communications between the video and/or audio capture device at the first location and a device at a second location;
c) transmitting notice from the server to the device at the second location upon occurrence of an activation event;
d) transmitting via the server audio and/or video data from the first user to the device at the second location either “live” or in archived form; and
e) transmitting via the server audio and/or video data from a device at the second location to the device at the first location.

The present invention provides, in another aspect a system for automatically toggling synchronous and asynchronous communications between at least two users, at two locations which comprises:
a) at least one video and/or audio capture device at a first location which acquires and synchronously and/or asynchronously transmits audio and/or video data from a first user via a server to a second user;
b) at least one video and/or audio capture device at a second location which acquires and synchronously and/or asynchronously transmits audio and/or video data from the second user via a server to the first user;
c) a computer processor operative with the video and/or audio capture device at the first location, which comprises at least one of the following: a motion detection means, a facial detection means and an environment change means, one or more of which enables triggering of an activation event by which audio and/or video data is transmitted from the first location to the server;
d) a computer processor operative with the video and/or audio capture device at the second location;
e) at least one video and/or audio capture device at the first location which receives, synchronously and/or asynchronously, audio and/or video data from the second user, via the server, after an activation event;
f) at least one video and/or audio capture device at the second location which receives, synchronously and/or asynchronously, audio and/or video data from the first user, via the server, after an activation event; and
g) the server, which undertakes one or more of the following actions: confirming secure communications between the video and/or audio capture devices at the first location and the second location, receiving audio and/or video data from the first user and the second user, transmitting a notification to the video and/or audio capture device at the second location after an activation event, transmitting video and/or audio data to the video and/or audio capture device at the second location after an activation event; transmitting video and/or audio data to the video from the second location to the video and/or audio capture device at the first location; recording and storing video and/or audio data for subsequent transmittal to the video and/or audio capture device at the first and/or second location.

The present invention provides, in another aspect a computer implemented method for automatically toggling synchronous and asynchronous communications between at least two users, at two locations which comprises:
a) upon the occurrence of an activation event at a first location, acquiring and synchronously and/or asynchronously transmitting audio and/or video data from a first user at the first location to a server;
b) confirming secure communications between the video and/or audio capture device at the first location and a device at a second location;
c) transmitting notice from the server to the device at the second location upon occurrence of an activation event;
d) transmitting via the server audio and/or video data from the first user to the device at the second location either “live” or in archived form; and
e) transmitting via the server audio and/or video data from a device at the second location to the device at the first location.

The present invention provides, in another aspect a machine readable non-transitory storage medium that stores executable instructions for automatically toggling synchronous and asynchronous communications between at least two users, at two locations which comprises:
a) upon the occurrence of an activation event at a first location, acquiring and synchronously and/or asynchronously transmitting audio and/or video data from a first user at the first location to a server;
b) confirming secure communications between the video and/or audio capture device at the first location and a device at a second location;
c) transmitting notice from the server to the device at the second location upon occurrence of an activation event;
d) transmitting via the server audio and/or video data from the first user to the device at the second location either “live” or in archived form; and
e) transmitting via the server audio and/or video data from a device at the second location to the device at the first location.

### Computer Systems

The systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions. In order to fully appreciate how the web-based cross-platform smart phone application creation and management system operates an understanding of suitable computing systems is useful. The web-based cross-platform smart phone application creation and management systems and methods disclosed herein are enabled as a result of application via a suitable computing system.

In one aspect, a computer system (or digital device), which may be understood as a logic apparatus adapted and configured to read instructions from media and/or network port, is connectable to a server and can have a fixed media. The computer system can also be connected to the Internet or an intranet. The system includes central processing unit (CPU), disk drives, optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an Internet connection.

It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

A user launches an app created by an app creator and downloaded to the user's mobile device to view digital content items and can connect to a front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website via an app at any time. The user may include a variety of different computing devices

There is provided herein a system that effectuates and/or facilitates mobile application delivery and reconfiguration to a plethora of disparate mobile devices. A system can include server/application delivery platform that can provide the ability to download an adaptable framework of the mobile application onto the mobile device.

An application delivery platform via network topology and/or cloud, can be in continuous and/or operative or sporadic and/or intermittent communication with a plurality of mobile devices utilizing over the air (OTA) data interchange technologies and/or mechanisms. As will be appreciated by those of reasonable skill in the art, mobile devices can include a disparity of different, diverse and/or disparate portable devices including Tablet PC's, server class portable computing machines and/or databases, laptop computers, notebook computers, cell phones, smart phones, transportable handheld consumer appliances and/or instrumentation, portable industrial devices and/or components, personal digital assistants, multimedia Internet enabled phones, multimedia players, and the like.

Application delivery platform can be implemented entirely in hardware and/or a combination of hardware and/or software in execution. Further, application delivery platform can be incorporated within and/or associated with other compatible components. Additionally, application delivery platform can be, but is not limited to, any type of machine that includes a processor and/or is capable of effective communication with network topology and/or cloud. Illustrative machines that can comprise application delivery platform can include desktop computers, server class computing devices, laptop computers, notebook computers, Tablet PCs, consumer and/or industrial devices and/or appliances, hand-held devices, and the like.

Network topology and/or cloud can include any viable communication and/or broadcast technology, for example, wired and/or wireless modalities and/or technologies can be utilized to effectuate the claimed subject matter. Moreover, network topology and/or cloud can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Furthermore, as those skilled in the art will appreciate and understand various data communications protocols (e.g., TCP/IP, Ethernet, Asynchronous Transfer Mode (ATM), Fiber Distributed Data Interface (FDDI), Fibre Channel, Fast Ethernet, Gigabit Ethernet, Wi-Fi, Token Ring, Frame Relay, etc.) can be utilized to implement suitable data communications.

Additionally application delivery server/platform may include a provisioning component that, based at least in part on input received from a portal component, can automatically configure and/or provision the various disparate mobile devices with appropriate applications.

It is to be appreciated that a store can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 206 of the subject systems and methods is intended to comprise, without being limited to, these and any other suitable types of memory. In addition, it is to be appreciated that the store can be a server, a database, a hard drive, and the like.

### Technology

The applications enabling the methods and systems described herein may be embodied in any one or more of the following technologies.

### C

C is an imperative (procedural) systems implementation language that was designed to be compiled using a relatively straightforward compiler, to provide low-level access to memory, to provide language constructs that map efficiently to machine instructions, and to require minimal run-time support. Despite its low-level capabilities, the language was designed to encourage machine-independent programming. A standards-compliant and portably written C program can be compiled for a very wide variety of computer platforms and operating systems with little or no change to its source code, while approaching highest performance. The language has become available on a very wide range of platforms, from embedded microcontrollers to supercomputers.

### Objective-C

Objective-C is a reflective, object-oriented programming language which adds Smalltalk-style messaging to C. Objective-C is a very thin layer on top of C that implements a strict superset of C. That is, it is possible to compile any C program with an Objective-C compiler. Objective-C derives its syntax from both C and Smalltalk. Most of the syntax (including preprocessing, expressions, function declarations, and function calls) is inherited from C, while the syntax for object-oriented features was created to enable Smalltalk-style messaging.

### Java

Java is a portable, object-oriented programming language that allows computer programs written in the Java language to run similarly on any supported hardware/operating-system platform. One should be able to write a program once, compile it once, and run it anywhere. This is achieved by compiling the Java language code, not to machine code but to Java byte code—instructions analogous to machine code but intended to be interpreted by a virtual machine (VM) written specifically for the host hardware. End-users commonly use a Java Runtime Environment (JRE) installed on their own machine for standalone Java applications, or in a Web browser for Java applets. Standardized libraries provide a generic way to access host specific features such as graphics, threading and networking. In some JVM versions, byte code can be compiled to native code, either before or during program execution, resulting in faster execution.

### JavaScript

JavaScript is a client-side object scripting language used by millions of Web pages and server applications. With syntax similar to Java and C++, JavaScript may behave as both a procedural and object oriented language. JavaScript is interpreted at run time on the client computer and provides various features to a programmer. Such features include dynamic object construction, function variables, dynamic script creation, and object introspection. JavaScript is commonly used to provide dynamic interactivity to Web pages and interact with a page DOM hierarchy.

### Ruby

Ruby is a dynamic, reflective, general-purpose object-oriented programming language that combines syntax inspired by Perl with Smalltalk-like features. Ruby supports multiple programming paradigms, including functional, object-oriented, imperative and reflective. It also has a dynamic type system and automatic memory management; it is therefore similar in varying respects to Python, Perl, Lisp, Dylan, and CLU.

### Web Services

A Web service (also Web Service) is defined by the W3C as “a software system designed to support interoperable machine-to-machine interaction over a network”. Web services are frequently just Web APIs that can be accessed over a network, such as the Internet, and executed on a remote system hosting the requested services. The W3C Web service definition encompasses many different systems, but in common usage the term refers to clients and servers that communicate over the HTTP protocol used on the Web. RESTful Web services are Web services that are based on the concept of representational state transfer (REST).

### Representational State Transfer (REST)

Representational state transfer (REST) is a style of software architecture for distributed hypermedia systems such as the World Wide Web. An important concept in REST is the existence of resources (sources of specific information), each of which is referenced with a global identifier (e.g., a URI in HTTP). In order to manipulate these resources, components of the network (user agents and origin servers) communicate via a standardized interface (e.g., HTTP) and exchange representations of these resources (the actual documents conveying the information). For example, a resource that is a circle may accept and return a representation that specifies a center point and radius, formatted in SVG, but may also accept and return a representation that specifies any three distinct points along the curve as a comma-separated list.

### XML

The Extensible Markup Language (XML) is a general-purpose specification for creating custom markup languages. It is classified as an extensible language, because it allows the user to define the mark-up elements. XML's purpose is to aid information systems in sharing structured data, especially via the Internet, to encode documents, and to serialize data; in the last context, it compares with text-based serialization languages such as JSON, YAML and S-Expression.

### JSON

JSON is an acronym for JavaScript Object Notation, and is a lightweight data exchange format. Commonly used in AJAX applications as an alternative to XML, JSON is human readable and easy to handle in client-side JavaScript. A single function call to eval( ) turns a JSON text string into a JavaScript object. Such objects may easily be used in JavaScript programming, and this ease of use is what makes JSON a good choice for AJAX implementations.

### AJAX

AJAX is an acronym for Asynchronous JavaScript and XML but has become synonymous for JavaScript applications that use the HTTP Request object. AJAX allows websites to asynchronously load data and inject it into the website without doing a full page reload. Additionally AJAX enables multiple asynchronous requests before receiving results. Overall the capability to retrieve data from the server without refreshing the browser page allows separation of data and format and enables greater creativity in designing interactive Web applications.

### HTML Push/Comet

Comet is similar to AJAX inasmuch as it involves asynchronous communication between client and server. However, Comet applications take this model a step further because a client request is no longer required for a server response.

### Server Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g. server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled.

Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

### EXAMPLES

### Example 1

### Searching for Data Points at Endpoints Using a Set of Criteria to Look for Activation Events and then Executing Action: Connection of the Endpoints Automatically in a Video Connection

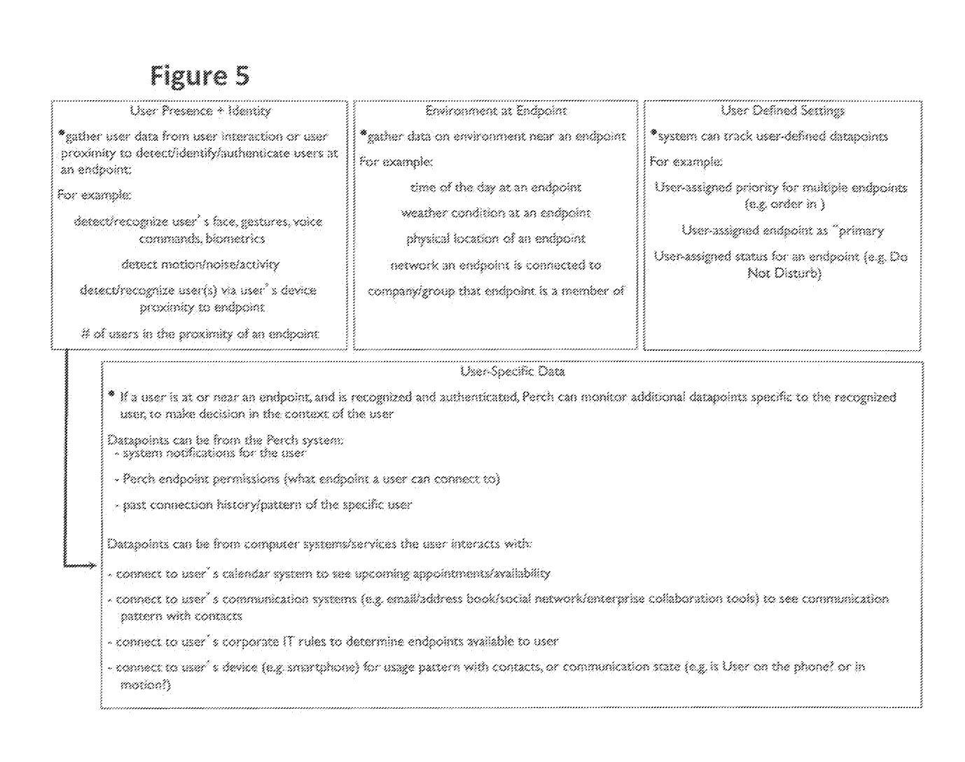

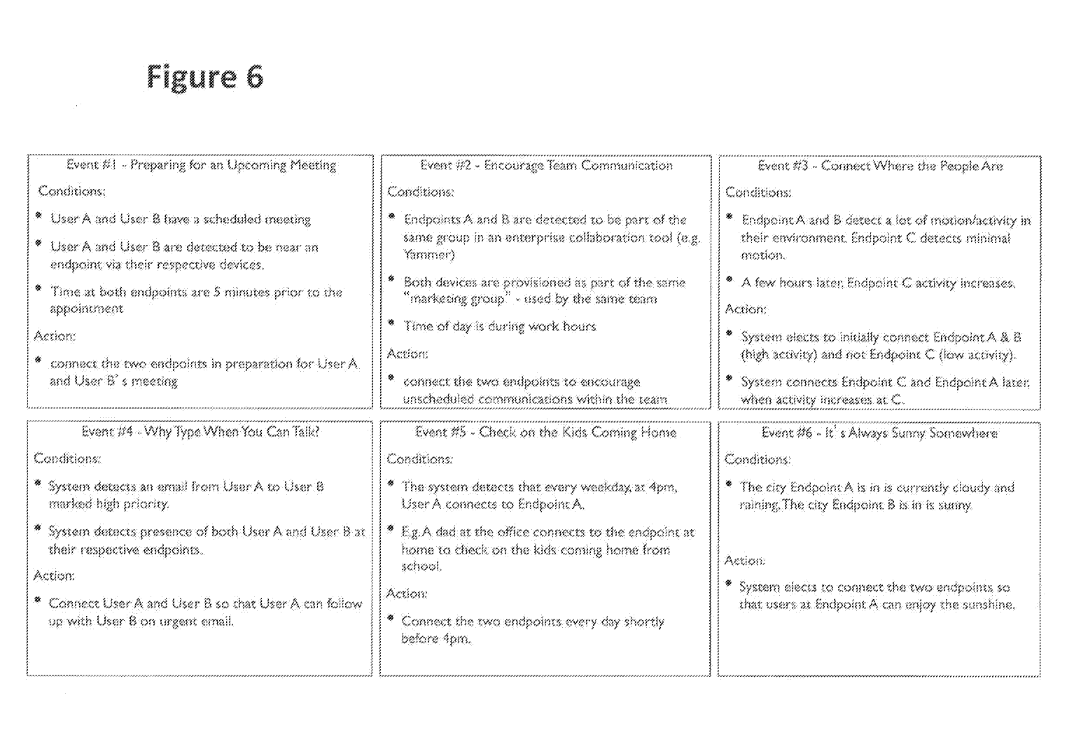

With reference to FIGS. 5 and 6, the following provides an example of a decision matrix in accordance with an embodiment of the present disclosure.

### #1 Monitoring Datapoints

A software as a service (SAS) platform (the “Perch Platform”) connects to various systems and monitors data points from a variety of sources, related to its users. Some data points include:

User Presence+Identity
gather user data from user interaction or user proximity to detect/identify/authenticate users at an endpoint:
For example:
detect/recognize user's face, gestures, voice commands, biometrics
detect motion/noise/activity
detect/recognize user(s) via user's device proximity to endpoint
# of users in the proximity of an endpoint

User-Specific Data
If a user is at or near an endpoint, and is recognized and authenticated, by the Perch Platform, additional data points can be monitored specific to the recognized user, to make decision in the context of the user

Datapoints can be from the Perch Platform:
system notifications for the user
Perch Platform endpoint permissions (what endpoint a user can connect to) past connection history/pattern of the specific user

Datapoints can be from Computer Systems/Services the User Interacts with:
connect to user's calendar system to see upcoming appointments/availability
connect to user's communication systems (e.g. email/address book/social network/enterprise collaboration tools) to see communication pattern with contacts
connect to user's corporate IT rules to determine endpoints available to user
connect to user's device (e.g. smartphone) for usage pattern with contacts, or communication state (e.g. is User on the phone? or in motion?)

#2 Look for Activation Events
Perch Platform analyzes available data points using a set of criteria to look for activation events.
Activation Events are conditional on a combinations of data points monitored by Perch Platform.
The combination of data points are such that they make logical sense to connect the device.
Currently, determining the combination of data points that form an activation event is determined by Perch Platform—but in the alternative it is possible for users to construct their own activation event with custom data points or conditions

### Example 2

### Preparing for an Upcoming Meeting

Conditions:
User A and User B have a scheduled meeting
User A and User B are detected to be near an endpoint via their respective devices.
Time at both endpoints is 5 minutes prior to the appointment

Action:
connect the two endpoints in preparation for User A and User B's meeting

### Example 3

### Encourage Team Communication

Conditions:
Endpoints A and B are detected to be part of the same group in an enterprise collaboration tool (e.g. Yammer)
Both devices are provisioned as part of the same “marketing group” used by the same team
Time of day is during work hours

Action:
connect the two endpoints to encourage unscheduled communications within the team

### Example 4

### Connect where the People are

Conditions:
Endpoint A and B detect a lot of motion/activity in their environment. Endpoint C detects minimal motion.
A few hours later, Endpoint C activity increases.

Action:
System elects to initially connect Endpoint A & B (high activity) and not Endpoint C (low activity).
System connects Endpoint C and Endpoint A later, when activity increases at C.

### Example 5

### Why Type when You can Talk?

Conditions:
System detects an email from User A to User B marked high priority.
System detects presence of both User A and User B at their respective endpoints.

Action:
Connect User A and User B so that User A can follow up with User B on urgent email.

### Example 6

### Check on the Kids Coming Home

Conditions:
The system detects that every weekday, at 4 pm, User A connects to Endpoint A.
E.g. A dad at the office connects to the endpoint at home to check on the kids coming home from school.

Action:
Connect the two endpoints every day shortly before 4 pm.

### Example 7

### It's Always Sunny Somewhere

Conditions:
The city Endpoint A is in is currently cloudy and raining. The city Endpoint B is in is sunny.

Action:
System elects to connect the two endpoints so that users at Endpoint A can enjoy the sunshine.

### Example 8

### Face-Detection Driven Microphone

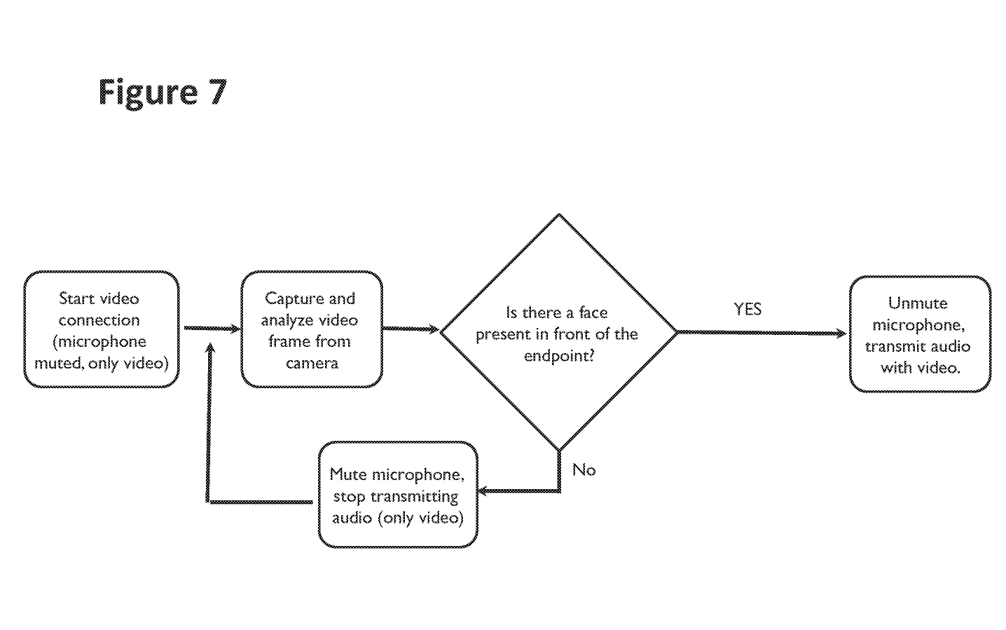

With reference to FIG. 7, the following example of a face-detection driven microphone process is presented.
Traditional video call is only started when communication is needed/convenient. But a video call can be “always connected” to create the experience of virtual presence.
With always-on, there can be a lot of distraction as background noise and unintended conversations are transmitted
There needs to be a way to avoid distraction, transmit only intended conversations, in an always connected scenario
Perch Platform uses face detection to determine the presence of someone intending to speak—then unmutes the microphone and transmits the captured audio.
When the system fails to detect the presence of someone intending to speak, the mic is muted again and the audio is no longer transmitted.
Video stream is connected and transmitted at all times.

How it Works
A video connection is established between two endpoints. The video connection is left connected to create the experience of virtual presence.
The endpoint uses the camera to monitor for the presence of a face.

### Example 9

### Meeting Queue

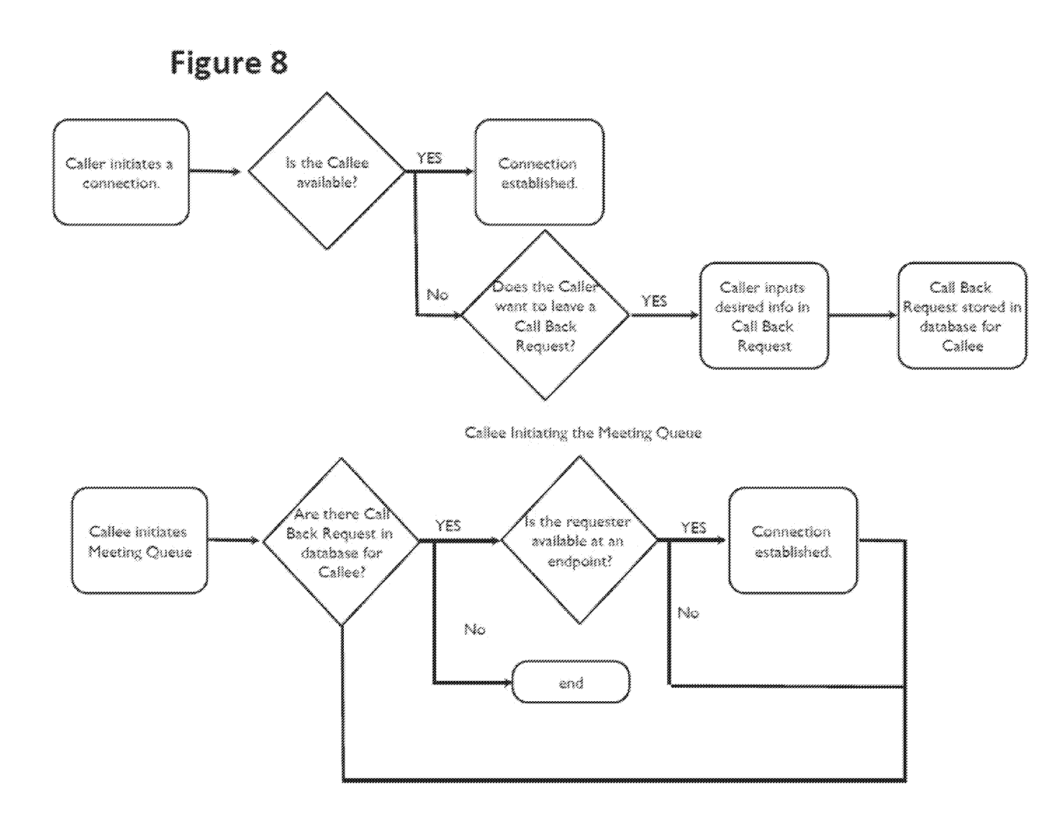

With reference to FIG. 8, the following example of a meeting queue is presented.
With traditional calling systems, there is a lot of telephone tag—a lot of coordinating time to talk
You can leave a voicemail, but voicemail is static content—once you leave a voicemail, it sits in voicemail.
Meeting Queue tracks who is trying to reach you and actively connects you to them when you are both available.
This allows for impromptu, serendipitous communications, that are conveniently unscheduled.

### How it Works

With Meeting Queue, if a Perch Platform user is not available, the caller is offered the option to leave a Call Back Request
A Call Back Request can also optionally include a character-limited short message (can be inputted as text, or transcribed into text).
A user's Call Back Requests contains:
who called; when it was; a short message (if available);
requester's presence—this data point is constantly updated, from data points monitored by the system, for as long as the Call Back Request is valid/not expired.
A Perch Platform user can review a list of Call Back Requests—people who tried to call—at the user's convenience
The Perch Platform user can see the requester's real-time presence—is he available?—if so, can immediately connect and talk
This is unlike voicemail—with voicemail, you can “call back”, but it does not have context like real-time presence
Voicemail also does not actively connect you, when all parties available
The user can also set the system to actively connect to available requesters sequentially automatically, like a queue.
Meeting Queue can leverage additional data points to be intelligent:
User facial recognition to identify user making the request (if request was made at a public endpoint)
Use facial recognition to identify location of a requester (so presence can be established and connection made)
Use device proximity to locate users—to know where user is available, and which endpoint to connect
Time of day—e.g. don't connect even if requester presence available, but out of business hour

### Meeting Queue—How it Works

Caller trying to connect to an unavailable Callee:

### Example 10

### Auto-Connect—Multiple Endpoints

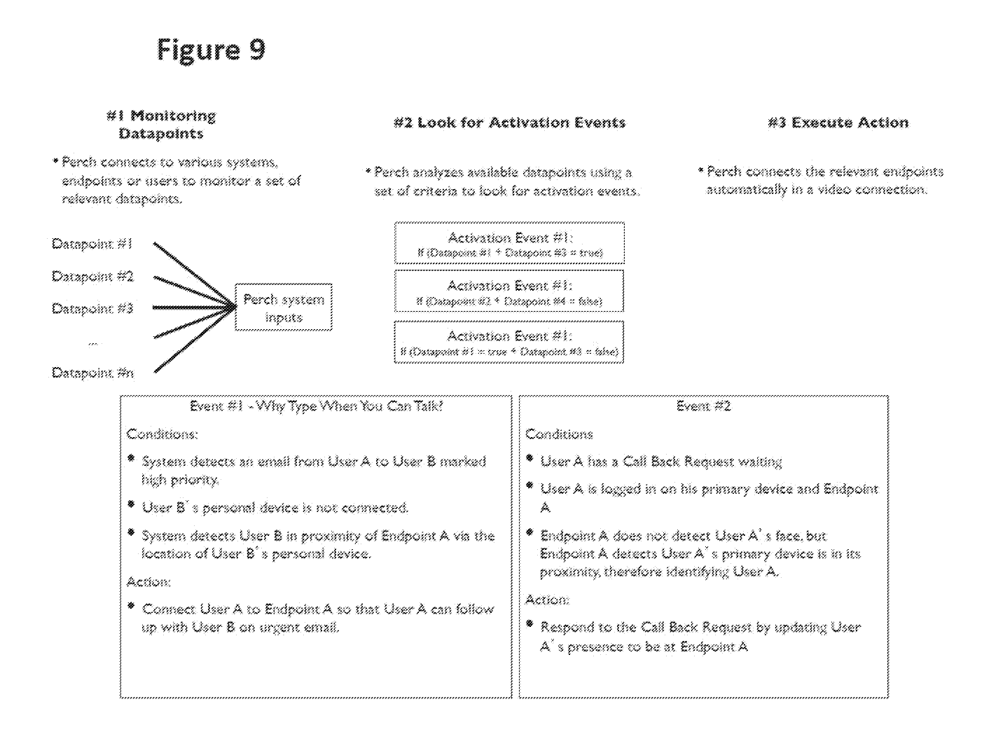

With reference to FIG. 9, the following illustrates auto-connect with multiple endpoints in an embodiments in accordance with the present disclosure.
Some calling systems allow a user to be logged in and reachable on multiple endpoints.
These systems alert the callee of an incoming call at all the reachable endpoints. The callee can then decide which endpoint is most suitable to answer the call, and then initiating the call by accepting it at the preferred endpoint.
But in a communication system that automatically connects endpoints, the system must be capable of making a decision on the preferred endpoint to connect and cannot rely on user intervention.
Auto-connect For Multiple Endpoints extends Auto-Connect but also intelligently selects the preferred endpoint, from a list of reachable endpoints for a user, to connect.
This allows a user to be reachable on multiple endpoints, without interrupting the user and leveraging the auto-connect functionality.
The same functionality can be applied to determine which endpoint to send notifications to.

How it Works
Auto-Connect for Multiple Endpoints leverages the much of the same data points monitored by the Auto-Connect functionality. This functionality relies on data points that indicate the presence, and identification of a user at endpoints
Using this subset of data points, additional Activation Events, specific to this functionality, are tracked by the system to enable this functionality.

Event #1—why Type when You can Talk?

Conditions:
System detects an email from User A to User B marked high priority.
User B's personal device is not connected.
System detects User B in proximity of Endpoint A via the location of User B's personal device.

Action:
Connect User A to Endpoint A so that User A can follow up with User B on urgent email.

Event #2

Conditions:

User A has a Call Back Request waiting
User A is logged in on his primary device and Endpoint A
Endpoint A does not detect User A's face, but Endpoint A detects User A's primary device is in its proximity, therefore identifying User A.

Action:
Respond to the Call Back Request by updating User A's presence to be at Endpoint A

### Example 11

### Transfer Call Between Multiple Endpoints

Beyond auto-connecting, having multiple endpoints presents possibility to affect the connection of an existing call.
A user may desire to begin a call with an endpoint, and as more appropriate endpoint becomes in proximity and available, to transfer the call to the appropriate endpoint.
The system monitors a subset of the same data points, focusing primarily on the proximity of nearby endpoints, and availability of said endpoints.
The system looks for conditions that fits a Activation Event, and upon such occurrence, presents the user with a prompt to transfer the call to the available endpoint.

How it Works
The Perch Platform monitors a subset of the data points monitored as part of the Auto-Connect functionality. The subset focuses on the proximity and availability of endpoints.

Event #1

Conditions:
User A is on a call using his personal device.
The personal device enters into proximity of Endpoint A, that is available.

Action:
System presents User A a prompt on his personal device, to transfer the call to Endpoint A.

### Example 12

### Pre-Buffer Stream to Multiple Endpoints

An issue encountered in transferring a stream from one endpoint to another is the continuity of the stream from one endpoint to the next—the user should have an immediate and smooth transition upon initiating the transfer.
To have an immediate transfer upon a user's request is difficult to accomplish smoothly because sufficient video data has to be present at the new endpoint for the video to be continuous.
Traditional known systems will not begin to establish a connection to the new endpoint, and subsequently transfer video data to the new endpoint until the user initiates the transfer.
The result is that the video will typically be paused, while a connection is established and video data transferred to the new endpoint.
This method and system of the present invention provides a seamless transition such that video is not interrupted and the transfer is immediate to the user.

How it Works
The Perch Platform constantly monitors data points to determine appropriate endpoints available for transfer to, and presents the best choice to the user to act on.
Due to this monitoring, the platform has knowledge of the endpoint that the user will transfer the stream to.
This allows the system to preemptively engage and prepare the new endpoint for the transfer—eliminating the need to do this, only upon the user initiating the transfer.
Once an endpoint is determined to be appropriate to transfer to, the system establishes a connection with the new endpoint and begins transferring the video data to the current and the new endpoint.
The new endpoint now has a buffer of video data, such that once the user initiates the transfer, the video has the data available on the new endpoint to carry on with no interruption.
If the user does not act on the prompt, the prompt expires, and the system ceases to stream the video data to the new endpoint and closes the connection.

We claim:

1. A method for audio and/or video communication between at least two endpoints in a networked environment comprises receiving a plurality of data (data points) via a plurality of notifiers/sensors/probes in the networked environment, said plurality of notifiers/sensors/probes monitoring the data points; analyzing the data points using at least one means of data analytics to determine a state of each endpoint and correlating the state of each endpoint with at least one pre-identified state, comparing state of endpoint to at least one pre-identified state to recognize if an activation event is triggered, wherein if the activation event is triggered, an action related to the pre-identified state is taken, wherein at least one of the steps is carried out by a computer device.

2. The method of claim 1 wherein data analytics comprising at least one method of processing data points selected from the group consisting of: simple Boolean programmable logic, expert systems, probabilistic methods and adaptive methods (including machine learning).

3. The method of claim 1 wherein using machine learning to analyze the data points to determine a state of each endpoint and to recognize if activation event is triggered comprises at least one of stochastic modeling, Support Vector Machines, Decision Trees, and Naieve Bayesian.

4. A computer storage medium encoded with a computer program, the program comprising instructions that when executed by one or more computers cause the one or more computers to perform operations relating to audio and/or video communication between at least two endpoints in a networked environment comprising: receiving a plurality of data (data points) via a plurality of notifiers/sensors/probes in the networked environment, said plurality of notifiers/sensors/probes monitoring the data points; analyzing the data points using at least one means of data analytics to determine a state of each endpoint and correlating the state of each endpoint with at least one pre-identified state, comparing state of endpoint to at least one pre-identified state to recognize if activation event is triggered, wherein if an activation event is triggered, an action related to the pre-identified state is taken.

5. A method for audio and/or video communication between at least two endpoints in a networked environment wherein a first user is at a first endpoint and a second user is at a second endpoint which comprises a) capturing and collecting data (data points) via a plurality of notifiers/sensors/probes in the networked environment, relating to at least one of the first user and the first endpoint (first endpoint collected data), and analyzing the first endpoint collected data to determine a state of the first endpoint b) capturing and collecting data (data points) via a plurality of notifiers/sensors/probes in the networked environment, relating to at least one of the second user and the second endpoint (second endpoint collected data) and analyzing the second endpoint collected data to determine a state of the second endpoint, c) correlating the state of at least one of the first endpoint and the second endpoint with at least one pre-identified state and comparing state of at least one endpoint to at least one pre-identified state to recognize if an activation event is triggered, wherein if the activation event is triggered, an action related to the pre-identified state is taken, wherein at least one of the steps is carried out by a computer device and wherein data points are analyzed using at least one means of data analytics

6. The method of claim 5 wherein data (data points) comprises at least one of: user specific features, endpoint features, user identity, user presence, environmental features at the endpoint, external cues, features and inputs and specific, pre-determined settings relating to the relationship between the first endpoint and the second endpoint.

7. The method of claim 5 wherein data (data points) relate to at least one of the user presence and identity and are captured and collected by at least one of: proximity detection means, facial detection means, voice detection means, motion detection means, gesture detection means, biometric detection means and audio detection means.

8. The method of claim 5 wherein data (data points) relate to environmental features selected from the group consisting of: time at an endpoint, day at an endpoint, weather at an endpoint, ambient light at an endpoint, physical location of an endpoint, network to which endpoint connected (or connectable), user at endpoint, group presence at endpoint, and corporate presence at endpoint.

9. The method of claim 5 wherein data (data points) relate to at least one of user cues and endpoint cues and are selected from the group consisting of: system notifications to user, previous connection history of user to any endpoint, previous connection patterns of user to any endpoint, user's availability, user's location and user's mobility.

10. The method of claim 5 wherein data (data points) relate to at least one of i) user's availability, location and mobility, any of which are detected via feedback from user's networked mobile device and ii) user generated data including data points generated or acquired by software and applications used by or connected to user on networked computing device or networked mobile device.

11. The method of claim 5 wherein data (data points) relate to external cues, features and inputs selected from the group consisting of: activities relating to a user, a company or a group related to user, calendar systems, email systems, contact lists, social networks, and enterprise collaboration systems.

12. The method of claim 5 wherein the action is related to operation of a communication system.

13. The method of claim 5 wherein the action is selected from the group consisting of: transmission of data between endpoints, transmission of audio between endpoints, transmission of video between endpoints, transmission of user presence data, initiation of a call between the first user and the second user, transferring a call by at least one user, sending a notification to the first user, the second user or a third party, transmission of a prompt to a user to take an action, storage of data, updating data, making computational changes to existing data/data points, generating or updating data for use within the system, streaming data to a server and thereafter, either synchronously or asynchronously (in any combination thereof) to one or more intended users/recipients at the endpoints and other actions as are defined by a user.

14. The method of claim 5 wherein a pre-determined combination of data points forms an activation event and wherein said pre-determined combination of data points is selected by one of: a) a third party service provider; b) a network provider; and c) a user.

15. The method of claim 5 wherein user is engaged with a microprocessing device selected from the group consisting of desktop computer, laptop computer, personal digital assistant, Smartphone and tablet.

16. The method of claim 5 wherein data analytics comprises at least one method of processing data points selected from the group consisting of: simple Boolean programmable logic, expert systems, probabilistic methods and adaptive methods (including machine learning).

17. The method of claim 5 wherein there are a plurality of users at a plurality of endpoints.

18. A computer storage medium encoded with a computer program, the program comprising instructions that when executed by one or more computers cause the one or more computers to perform operations relating to audio and/or video communication between at least two endpoints in a networked environment wherein a first user is at a first endpoint and a second user is at a second endpoint comprising: a) capturing and collecting data (data points) via a plurality of notifications/sensors/probes in the networked environment, relating to at least one of the first user and the first endpoint (first endpoint collected data), and analyzing the first endpoint collected data to determine a state of the first endpoint b) capturing and collecting data (data points) via a plurality of notifications/sensors/probes in the networked environment, relating to at least one of the second user and the second endpoint (second endpoint collected data) and analyzing the second endpoint collected data to determine a state of the second endpoint, c) correlating the state of at least one of the first endpoint and the second endpoint with at least one pre-identified state and comparing state of at least one endpoint to at least one pre-identified state to recognize if an activation event is triggered, wherein if the activation event is triggered, an action related to the pre-identified state is taken and wherein data points are analyzed and activation events recognized using at least one means of data analytics

19. A system for audio and/or video communication between at least two endpoints in a networked environment wherein a first user is at a first endpoint on a first system and a second user is at a second endpoint on a second system which comprises:
a) a communication control server (CCS)
b) a video-over-telephony system (VOIPS) enabling communication between first endpoint and second endpoint;
c) at least one video and/or audio capture device and microprocessor at a each of first endpoint and second endpoint; and
d) at least one external data interface add storage (EDIS);
wherein said CCS collects data points, analyzes data points and compares the state of at least one endpoint to at least one pre-identified state to recognize if an activation event is triggered, wherein if the activation event is triggered, an action related to the pre-identified state is taken.

20. The system of claim 19 wherein CCS comprises a data sources hub into which is relayed data points from or relating to endpoints and data from EDIS; an activation event database and a CCS database.

21. A method for optimizing the conveyance and display of information to a first user at a first endpoint in regards to an audio and/or video communication between at least two endpoints (including the first endpoint) in a networked environment which comprises:
a) capturing and collecting data (data points) via at least one of i) a plurality of notifiers/sensors/probes in the networked environment, relating to at least one of the first user and the first endpoint and ii) an external data interface and storage system (EDIS) and wherein such data points relate at least to the first user, the environment and the endpoints and wherein EDIS comprises appropriate API Connectors to access, query and acquire the data points from the external systems;
b) comparing the data points to a proposed start time for an audio and/or video transfer/communication requiring presence and/or engagement of the user; and
c) leveraging the data points to augment the way in which one or more of the endpoints are accessible to, visible to or arranged for the first user.
